(19) United States
(12) Patent Application Publication
(10) Pub. No.: US 2014/0329946 A1
(43) Pub. Date: Nov. 6, 2014

(54) RUBBER COMPOSITION AND MANUFACTURING METHOD FOR SAME

(71) Applicant: BRIDGESTONE CORPORATION, Chuo-ku, Tokyo (JP)

(72) Inventors: Satoshi Horie, Tokyo (JP); Takumi Toda, Tokyo (JP); Noriaki Yukimura, Tokyo (JP)

(73) Assignee: BRIDGESTONE CORPORATION, Chuo-ku, Tokyo (JP)

(21) Appl. No.: 14/350,719

(22) PCT Filed: Oct. 19, 2012
(86) PCT No.: PCT/JP2012/077167

§ 371 Date: Apr. 9, 2014

(30) Foreign Application Priority Data
Oct. 21, 2011 (JP) 2011-232265
Oct. 21, 2011 (JP) 2011-232267
Nov. 11, 2011 (JP) 2011-247935
Nov. 22, 2011 (JP) 2011-254761
Dec. 21, 2011 (JP) 2011-280565
Jan. 16, 2012 (JP) 2012-006228

(51) Int. Cl. C08K 13/02; C08L 9/06; C08L 7/00

(52) U.S. Cl. CPC C08K 13/02; C08L 7/00; C08L 9/06; C08L 2666/38; C08L 2205/025
USPC 524/154; 524/216; 524/186

(57) ABSTRACT

The present invention is a rubber composition containing a rubber component, a specific hydroxy group-having thiourea derivative, a thioamide compound, an acidic compound, a combination of a nucleophilic reagent except guanidine compounds and a guanidine compound, a compound selected from a phosphorous acid compound and a salt of a phosphorous acid compound, and a filler containing an inorganic filler, and a method for the rubber composition, providing the rubber composition having an improved low-heat-generation property and its production method.

### TECHNICAL FIELD

The present invention relates to a rubber composition capable of having an improved low-heat-generation property, and to a method for producing the rubber composition.

### BACKGROUND ART

Recently, in association with the movement of global regulation of carbon dioxide emission associated with the increase in attraction to environmental concerns, the demand for low fuel consumption by automobiles is increasing. To satisfy the requirement, it is desired to reduce the rolling resistance of tires, and further, it is desired to reduce the rolling resistance not lowering the high braking performance thereof on wet road surfaces.

As a technique of satisfying both rolling resistance reduction (low-heat-generation property) and high braking performance on wet road surfaces (wet braking performance), it is effective to use, as a filler, an inorganic filler such as silica or the like.

PTL 1 proposes a possibility of providing a rubber composition excellent in low rolling resistance (low-heat-generation property), wet braking performance, abrasion resistance, workability and the like without causing rubber burning, by using a small amount of a silane coupling agent in combination with a nonionic surfactant.

PTL 2 discloses a method of using a polymer that has an increased affinity to an inorganic filler such as silica or the like and to carbon black.

PTL 3 proposes using an organosilanes disulfide having a relatively high purity as a silane coupling agent in a rubber-silica premixing step and also using therein, as a silica-silane reaction activator, at least one sulfur donor of (1) elementary sulfur and (2) a sulfur-containing polysulfide-type organic compound having the property of releasing at least a part of sulfur at about 140° C. to about 190° C. Further, approaches have been made to reducing a volatile alcoholic component such as ethanol or the like by substituting a part of the alkoxy group in a silane coupling agent with an alkyl group (see PTL 4 to 7). In PTL 8 and 9, it is written that the heat generation property of a rubber composition can be lowered by increasing the affinity between the filler such as carbon black or the like and the rubber component therein. The publications disclose that tires having a low hysteresis loss can be therefore obtained.

However, it is desired to further enhance the low-heat-generation property.

### PRIOR ART DOCUMENTS

### Patent Documents

PTL 1: JP-A H11-130908
PTL 2: JP-A 2003-514079
PTL 3: JP-A H8-259739
PTL 4: JP-A 2002-275311
PTL 5: JP-A 2004-525230
PTL 6: WO2004/000930
PTL 7: JP-A 2006-169538
PTL 8: JP-A 2003-514079
PTL 9: WO2007/066689

### SUMMARY OF THE INVENTION

### Problems to be Solved by the Invention

The present invention is intended to provide a rubber composition capable of improving the low-heat-generation property of rubber products such as tires, etc., and to provide a production method for the rubber composition.

### Means for Solving the Problems

For solving the above-mentioned problems, the present inventors have made various experimental analyses and, as a result, have found that the dispersibility of filler can be further improved by using a specific compound, and have completed the present invention.

Specifically, the present invention includes the following:

[1] A rubber composition, which contains a rubber component (A), at least one organic sulfur compound (B) selected from a hydroxy group-having thiourea derivative (B-1) represented by the following general formula (I) and a thioamide compound (B-2) represented by the following general formula (II), and a filler containing an inorganic filler (C):

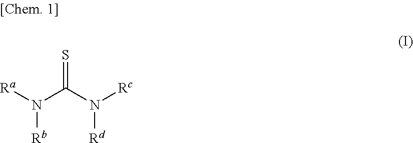

[wherein R^{a}, R^{b}, R^{c} and R^{d} may be the same or different, each representing a functional group selected from an alkyl group, an alkyl group having a hydroxy group, an alkenyl group, an alkenyl group having a hydroxy group, an aryl group and an aryl group having a hydroxy group, or a hydrogen atom, and at least one of R^{a}, R^{b}, R^{c} and R^{d} is a functional group selected from an alkyl group having a hydroxy group, an alkenyl group having a hydroxy group and an aryl group having a hydroxy group.],

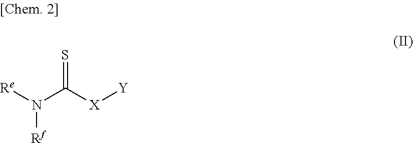

[wherein R^{e} and R^{f} each independently represent any of a hydrogen atom, an aliphatic hydrocarbon group having from 1 to 10 carbon atoms, and an aromatic hydrocarbon group having from 6 to 20 carbon atoms; X represents any of a single bond, an aliphatic hydrocarbon group having from 1 to 10 carbon atoms, and an aromatic hydrocarbon group having from 6 to 20 carbon atoms; Y represents at least one selected from a hydrogen atom, an alkyl group having from 1 to 5 carbon atoms, a hydroxy group, an amino group and a halogen atom; and at least one of R^{e} and R^{f} may bond to X];
[2] The rubber composition according to the above [1], wherein the organic sulfur compound (B) is a hydroxy group-having thiourea derivative (B-1) represented by the general formula (I);
[3] The rubber composition according to the above [1], wherein the organic sulfur compound (B) is a thioamide compound (B-2) represented by the general formula (II), and the composition further contains a silane coupling agent (D);
[4] A method for producing a rubber composition that contains a rubber component (A), a hydroxy group-having thiourea derivative (B-1) represented by the general formula (I), and a filler containing an inorganic filler (C); the method including at least a first kneading stage of kneading the rubber component (A), the hydroxy group-having thiourea derivative (B-1), and all or a part of the inorganic filler (C), and, after the first kneading stage, a final kneading stage of adding thereto a vulcanizing agent and further kneading them;
[5] A method for producing a rubber composition that contains a rubber component (A), a thioamide compound (B-2) represented by the general formula (II), a filler containing an inorganic filler (C), and a silane coupling agent (D); wherein the rubber composition is kneaded in plural stages, and in the first kneading stage, the rubber component (A), all or a part of the inorganic filler (C), all or a part of the silane coupling agent (D), and the thioamide compound (B-2) represented by the general formula (II) are kneaded;
[6] A method for producing a rubber composition that contains a rubber component (A), an acidic compound (B-3) of which the logarithmic value pKa of the reciprocal number of the acid dissociation constant Ka is 4 or less, and a filler containing an inorganic filler (C); the method including at least a first kneading stage of kneading the rubber component (A), the acidic compound (B-3), and all or a part of the inorganic filler (C), and, after the first kneading stage, a final kneading stage of adding thereto a vulcanizing agent and further kneading them, wherein the method for measuring pKa comprises analyzing the compound in an aqueous solution at a temperature of 25° C. with a pH measuring apparatus, and the value in the dissociation stage 1 is pKa of the compound;
[7] A rubber composition that contains a rubber component (A), a nucleophilic reagent (B-4) except guanidine compounds, a guanidine compound (B-5), and a filler containing an inorganic filler (C);
[8] The rubber composition according to the above [7], wherein the nucleophilic reagent (B-4) except guanidine compounds is at least one compound selected from cysteine and a cysteine derivative (b) represented by the following general formula (III):

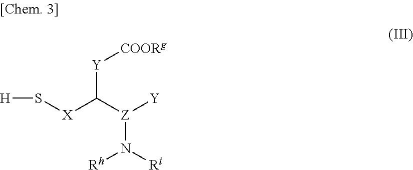

[wherein X represents a divalent hydrocarbon group having a linear alkylene group and having from 1 to 10 carbon atoms; Y and Z each independently represent a single bond or an alkylene group having from 1 to 10 carbon atoms; R^{g} is selected from a hydrogen atom, an aliphatic hydrocarbon group, an alicyclic hydrocarbon group, an aromatic hydrocarbon group and an alkali metal; R^{h} and Rⁱ each are independently selected from a hydrogen atom, an aliphatic hydrocarbon group, an alicyclic hydrocarbon group, an aromatic hydrocarbon group and an acyl group; the —COO moiety may form a salt with an amine; the —NR^{h}Rⁱ moiety may form a salt with an acid; however, when all of R^{g}, R^{h} and Rⁱ are hydrogen atoms, the compound must form a salt, and in case where the compound does not form a salt, at least one of R^{g}, R^{h} and Rⁱ is not a hydrogen atom;
[9] A method for producing a rubber composition that contains a rubber component (A), a nucleophilic reagent (B-4) except guanidine compounds, a guanidine compound (B-5), and a filler containing an inorganic filler (C); the method including a first kneading stage of kneading the rubber component (A), the nucleophilic reagent (B-4), the guanidine compound (B-5) and all or a part of the inorganic filler (C), and, after the first kneading stage, a final kneading stage of adding thereto a vulcanizing agent and further kneading them;
[10] The method for producing a rubber composition according to the above [9], wherein the nucleophilic reagent (B-4) except guanidine compounds is at least one compound selected from cysteine and a cysteine derivative (b) represented by the general formula (III);
[11] A rubber composition that contains a rubber component (A), a phosphorous acid compound (B-6) represented by the following general formula (IV) or a salt of the phosphorous acid compound (B-6), a filler containing an inorganic filler (C), and a silane coupling agent (D):

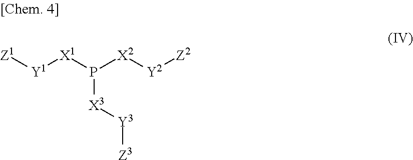

[wherein X¹, X² and X³ each independently represent an oxygen atom or —CH₂—; Y¹, Y² and Y³ each independently represent at least one selected from a single bond, a linear or branched aliphatic hydrocarbon group having from 1 to 6 carbon atoms, and an aromatic hydrocarbon group having from 6 to 20 carbon atoms; Z¹, Z² and Z³ each independently represent at least one selected from a hydrogen atom, a linear or branched aliphatic hydrocarbon group having from 1 to 6 carbon atoms, and a carboxyl group]; and
[12] A method for producing a rubber composition that contains a rubber component (A), a filler containing an inorganic filler (C), a silane coupling agent (D), and a phosphorous acid compound (B-6) represented by the general formula (IV) or a salt of the phosphorous acid compound (B-6); wherein the rubber composition is kneaded in plural stages, and in the first kneading stage, the rubber component (A), all or a part of the inorganic filler (C), all or a part of the silane coupling agent (D), and the phosphorous acid compound (B-6) represented by the general formula (IV) or a salt of the phosphorous acid compound (B-6) are kneaded.

### Effects of the Invention

According to the present invention, there are provided a rubber composition capable of improving the low-heat-generation property of tires, and a method for producing the rubber composition.

### MODES FOR CARRYING OUT THE INVENTION

The present invention is described in detail hereinunder.

### [Rubber Composition]

The rubber composition of the first aspect of the present invention is a rubber composition that contains a rubber component (A), at least one organic sulfur compound (B) selected from a hydroxy group-having thiourea derivative (B-1) represented by the following general formula (I) and a thioamide compound (B-2) represented by the following general formula (II), and a filler containing an inorganic filler (C).

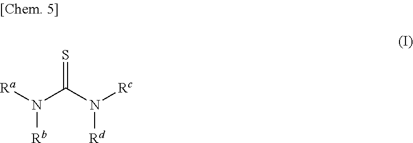

In the formula, R^{a}, R^{b}, R^{c} and R^{d} may be the same or different, each representing a functional group selected from an alkyl group, an alkyl group having a hydroxy group, an alkenyl group, an alkenyl group having a hydroxy group, an aryl group and an aryl group having a hydroxy group, or a hydrogen atom, and at least one of R^{a}, R^{b}, R^{c} and R^{d} is a functional group selected from an alkyl group having a hydroxy group, an alkenyl group having a hydroxy group and an aryl group having a hydroxy group.

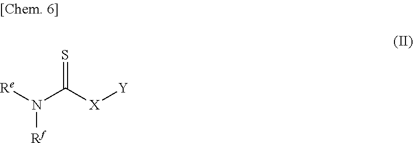

In the formula, R^{e} and R^{f} each independently represent any of a hydrogen atom, an aliphatic hydrocarbon group having from 1 to 10 carbon atoms, and an aromatic hydrocarbon group having from 6 to 20 carbon atoms; X represents any of a single bond, an aliphatic hydrocarbon group having from 1 to 10 carbon atoms, and an aromatic hydrocarbon group having from 6 to 20 carbon atoms; Y represents at least one selected from a hydrogen atom, an alkyl group having from 1 to 5 carbon atoms, a hydroxy group, an amino group and a halogen atom; and at least one of R^{e} and R^{f} may bond to X.

In the rubber composition of the first embodiment of the first aspect of the present invention mentioned above, the organic sulfur compound (B) is a hydroxy group-having thiourea derivative (B-1) represented by the above-mentioned general formula (I).

In the general formula (I), the carbon number of the alkyl group and that of the hydroxy group-having alkyl group in R^{a}, R^{b}, R^{c} and R^{d} each are preferably from 1 to 20, more preferably from 1 to 10.

The carbon number of the alkenyl group and that of the hydroxy group-having alkenyl group in R^{a}, R^{b}, R^{c} and R^{d} each are preferably from 2 to 20, more preferably from 2 to 10. The alkenyl group is especially preferably an allyl group.

The carbon number of the aryl group and that of the hydroxy group-having aryl group in R^{a}, R^{b}, R^{c} and R^{d} each are preferably from 6 to 20, more preferably from 6 to 16. The aryl group is especially preferably a phenyl group, a benzyl group, a phenethyl group or an alkyl group-substituted phenyl group (in which, for example, the alkyl group has from 1 to 6 carbon atoms).

Incorporating the hydroxy group-having thiourea derivative (B-1) represented by the general formula (I) {hereinafter this may be abbreviated as “hydroxy group-having thiourea derivative (B-1)”} in the rubber composition of the present invention significantly improves the dispersibility of filler and therefore significantly improves the low-heat-generation property of the rubber composition.

Preferably, the rubber composition of the first embodiment of the first aspect of the present invention further contains a silane coupling agent (D).

Preferably, in the rubber composition of the second embodiment of the first aspect of the present invention, the organic sulfur compound (B) is a thioamide compound (B-2) represented by the general formula (II) {hereinafter this may be abbreviated as “thioamide compound (B-2)”}, and also preferably, the rubber composition further contains a silane coupling agent (D). Accordingly, there can be obtained a rubber composition capable of improving the low-heat-generation property of tires, not worsening the abrasion resistance of tires.

The rubber composition of the second aspect of the present invention is a rubber composition that contains a nucleophilic reagent (B-4) except guanidine compounds, a guanidine compound (B-5), and a filler containing an inorganic filler (C).

Incorporating the nucleophilic reagent (B-4) except guanidine compounds and the guanidine compound (B-5) in the rubber composition significantly improves the dispersibility of filler and therefore significantly improves the low-heat-generation property of the rubber composition.

The rubber composition of the third aspect of the present invention is a rubber composition that contains a rubber component (A), a phosphorous acid compound (B-6) represented by the following general formula (IV) or a salt of the phosphorous acid compound (B-6), a filler containing an inorganic filler (C), and a silane coupling agent (D).

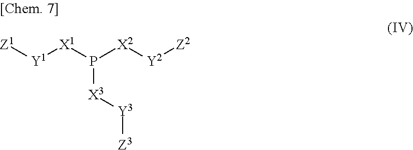

In the general formula (IV), X¹, X² and X³ each independently represent an oxygen atom or —CH₂—; Y¹, Y² and Y³ each independently represent at least one selected from a single bond, a linear or branched aliphatic hydrocarbon group having from 1 to 6 carbon atoms, and an aromatic hydrocarbon group having from 6 to 20 carbon atoms; Z¹, Z² and Z³ each independently represent at least one selected from a hydrogen atom, a linear or branched aliphatic hydrocarbon group having from 1 to 6 carbon atoms, and a carboxyl group.

Incorporating the phosphorous acid compound (B-6) represented by the following general formula (IV) {hereinafter this may be abbreviated as “phosphorous acid compound (B-6)”} or a salt of the phosphorous acid compound (B-6) into the rubber composition may improve the dispersibility of the filler in the rubber composition. In particular, the reactivity between the silane coupling agent and the inorganic filler such as silica or the like can be improved, and the dispersion of the inorganic filler such as silica or the like in the rubber composition can be thereby bettered, and accordingly, a rubber composition having an excellent low-heat-generation property can be obtained here.

A single bond of Y¹ means that X¹ bonds to Z¹ via a single bond.

### [Rubber Component (A)]

The rubber component (A) for use in the rubber composition of the present invention is preferably a rubber component comprising at least one selected from natural rubber and synthetic dienic rubber. As the synthetic dienic rubber, usable here are styrene-butadiene copolymer rubber (SBR), polybutadiene rubber (BR), polyisoprene rubber (IR), butyl rubber (IIR), ethylene-propylene-diene tercopolymer rubber (EPDM), etc. One alone or two or more different types of natural rubber and synthetic dienic rubber may be used here either singly or as blended.

### [Hydroxy Group-Having Thiourea Derivative (B-1)]

In the hydroxy group-having thiourea derivative (B-1) represented by the general formula (I) in the present invention, preferably, R^{a} is a substituent selected from an allyl group, an alkyl group-substituted allyl group (in which the carbon number of the alkyl group is preferably from 1 to 10, more preferably from 1 to 6), and an allyl group-having alkenyl group, R^{b} is a hydrogen atom, R^{c} is a substituent selected from a hydroxy group-having alkyl group, a hydroxy group-having alkenyl group and a hydroxy group-having aryl group, and R^{d} is a hydrogen atom.

The case where R^{a} is a substituent selected from an allyl group, an alkyl group-substituted allyl group and an allyl group-having alkenyl group is preferred owing to the electron-donating effect, the case where R^{b} is a hydrogen atom is preferred owing to the reduction in steric hindrance; the case where R^{c} is a substituent selected from a hydroxy group-having alkyl group, a hydroxy group-having alkenyl group and a hydroxy group-having aryl group is preferred owing to the improvement of the interaction with the inorganic filler (C) to be mentioned below, especially silica; and the case where R^{d} is a hydrogen atom is preferred owing to the reduction in steric hindrance.

As specific examples of the hydroxy group-having thiourea derivative (B-1), preferably mentioned are 1-allyl-3-(2-hydroxyethyl)-2-thiourea, 2-hydroxyethyl-thiourea, 3-hydroxypropyl-thiourea, etc.

Preferably, the hydroxy group-having thiourea derivative (B-1) to be contained in the rubber composition of the first embodiment of the first aspect of the present invention is incorporated in the composition in an amount of from 0.1 to 5 parts by mass per 100 parts by mass of the rubber component (A) therein. The amount of 0.1 parts by mass or more can exhibit a sufficient effect of improving the dispersibility of filler, and the amount of 5 parts by mass or less does not have any significant influence on the vulcanization speed. More preferably, the amount of the hydroxy group-having thiourea derivative (B-1) is from 0.2 to 3 parts by mass per 100 parts by mass of the rubber component (A).

### [Thioamide Compound (B-2)]

The thioamide compound (B-2) is represented by the general formula (II). Incorporating the thioamide compound (B-2) represented by the general formula (II) in the composition improves the dispersibility of the filler including the inorganic filler (C) in the rubber composition of the present invention.

In the general formula (II), R^{e} and R^{f} each independently represent any of a hydrogen atom, an aliphatic hydrocarbon group having from 1 to 10 carbon atoms, and an aromatic hydrocarbon group having from 6 to 20 carbon atoms.

The aliphatic hydrocarbon group having from 1 to 10 carbon atoms for R^{e} and R^{f} includes, for example, a methyl group, an ethyl group, a propyl group, a butyl group, a pentyl group, a hexyl group, etc., which may be branched. The aromatic hydrocarbon group having from 6 to 20 carbon atoms for R^{e} and R^{f} includes, for example, a phenyl group, a diphenyl group, etc. As R^{e} and R^{f}, especially preferred are a case where both R^{e} and R^{f} are hydrogen atoms; a case where one of R^{e} and R^{f} is a hydrogen atom and the other is a methyl group; a case where one of R^{e} and R^{f} is a hydrogen atom and the other is a phenyl group; and a case where one of R^{e} and R^{f} is a hydrogen atom or an aliphatic hydrocarbon group and the aliphatic hydrocarbon group bonds to X to form a cyclic polymethylene group structure.

X represents any of a single bond, an aliphatic hydrocarbon group having from 1 to 10 carbon atoms, and an aromatic hydrocarbon group having from 6 to 20 carbon atoms; and Y represents at least one selected from a hydrogen atom, an alkyl group having from 1 to 5 carbon atoms, a hydroxy group, an amino group and a halogen atom.

The case where X is a single bond provides a structure in which X is absent and Y bonds to the carbon atom bonding to the sulfur atom, directly via a single bond and not via X. The aliphatic hydrocarbon group having from 1 to 10 carbon atoms for X includes a methyl group, an ethyl group, a propyl group, a butyl group, a pentyl group, a hexyl group, etc., which may be branched. The aromatic hydrocarbon group having from 6 to 20 carbon atoms for X includes a phenyl group, a diphenyl group, etc.

Y represents at least one selected from a hydrogen atom, an alkyl group having from 1 to 5 carbon atoms, a hydroxy group, an amino group and a halogen atom. In the case where X is an aliphatic hydrocarbon group having from 1 to 10 carbon atoms or an aromatic hydrocarbon group having from 6 to 20 carbon atoms, Y bonds to the hydrocarbon group. As described above, in the case where X is a single bond, Y provides a structure directly bonding to the carbon atom that bonds to the sulfur atom.

At least one of R^{e} and R^{f} may bond to X. A specific structure where at least one of R^{e} and R^{f} bonds to X includes a polymethylene group structure as mentioned above. Examples of the polymethylene group include a dimethylene group, a trimethylene group, a tetramethylene group, a pentamethylene group, a hexamethylene group, etc.

Also as mentioned above, especially preferred is a case where one of R^{e} and R^{f} is a hydrogen atom or a methyl group and the other bonds to X, providing a cyclic polymethylene group structure.

Concretely, preferred examples of the thioamide compound (B-2) represented by the general formula (II) include thioacetamide, thiopropionamide, thioacetanilide, 4-chlorothiobenzamide, 4-hydroxythiobenzamide, εE-thiocaprolactam, 1-methylpyrrolidine-2-thione, N-phenylthiobenzamide, thiobenzamide, etc. The structures of these specific compounds are represented by the following formulae:

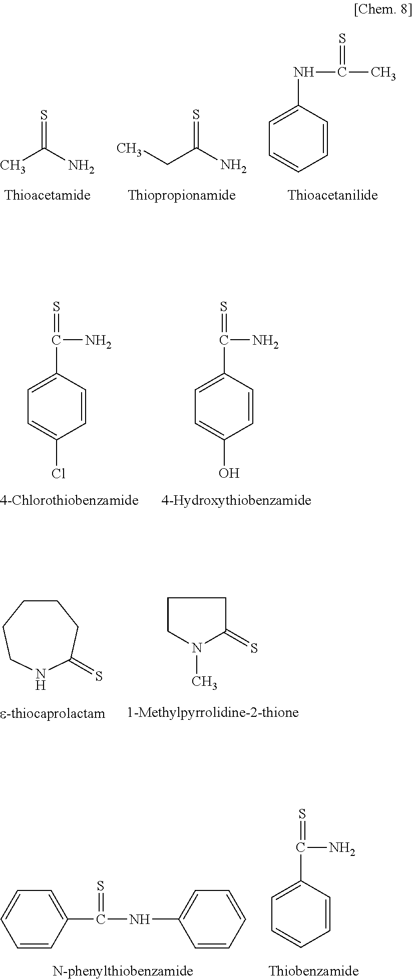

Of those thioamide compounds (B-2), especially preferred is use of thioacetamide, thiobenzamide and 1-methylpyrrolidine-2-thione.

Using thioacetamide, thiobenzamide and 1-methylpyrrolidine-2-thione is especially preferred as facilitating the interaction with the silane coupling agent (D), if any, in the rubber composition as described below.

The thioamide compound (B-2) is incorporated in an amount of generally from 0.1 to 5 parts by mass per 100 parts by mass of the rubber component. Preferably, the amount is from 0.2 to 3 parts by mass, more preferably from 0.3 to 2 parts by mass. The amount of the thioamide compound (B-2) falling within a range of from 0.1 to 5 parts by mass increases the dispersing effect of the filler containing an inorganic filler (C) in the rubber composition.

### [Acidic Compound (B-3)]

The acidic compound (B-3) in the third aspect of the present invention relating to a production method for the rubber composition of the present invention, which will be described below, is an acidic compound of which the value pKa measured with a pH measuring apparatus in an aqueous solution thereof at a temperature of 25° C. in the dissociation stage 1 is 4 or less. Concretely, there are mentioned maleic acid (1.84), cyclopropane-1,1-dicarboxylic acid (1.68), phthalic acid (2.75), fumaric acid (3.07), citric acid (2.90), oxalic acid (1.04), malonic acid (2.60), methylmalonic acid (2.89), (+)-tartaric acid (2.87), meso-tartaric acid (2.95), o-aminobenzoic acid (1.97), 4-aminosalicylic acid (2.05), 2-aminobutyric acid (2.54), o-chlorobenzoic acid (2.95), o-nitrobenzoic acid (2.87), nitroacetic acid (1.34), oxaloacetic acid (2.55), phenoxyacetic acid (2.93), bromoacetic acid (2.82), chloroacetic acid (2.66), cyanoacetic acid (2.65), dichloroacetic acid (1.30), 2-bromopropionic acid (2.97), etc. Of those, most preferred is maleic acid (1.84).

The pKa value is in the parenthesis.

### [Nucleophilic Reagent (B-4) Except Guanidine Compounds]

As the nucleophilic reagent (B-4) except guanidine compound in the rubber composition of the second aspect of the present invention {hereinafter this may be abbreviated as “nucleophilic reagent (B-4)”}, there are mentioned cysteine, cysteine derivatives, thiourea, thiourea derivatives, thiobenzamide, thiobenzamide derivatives, piperidinium pentamethylenedithiocarbamate, etc. From the viewpoint of further improving the dispersibility of filler, preferred is at least one compound selected from cysteine and cysteine derivatives (b) represented by the following general formula (III); and more preferred is cysteine.

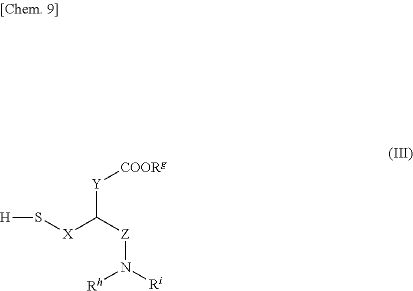

In the general formula (III), X represents a divalent hydrocarbon group having a linear alkylene group and having from 1 to 10 carbon atoms; Y and Z each independently represent a single bond or an alkylene group having from 1 to 10 carbon atoms; R^{g} is selected from a hydrogen atom, an aliphatic hydrocarbon group, an alicyclic hydrocarbon group, an aromatic hydrocarbon group and an alkali metal; R^{h} and Rⁱ each are independently selected from a hydrogen atom, an aliphatic hydrocarbon group, an alicyclic hydrocarbon group, an aromatic hydrocarbon group and an acyl group; the —COO moiety may form a salt with an amine; the —NR^{h}Rⁱ moiety may form a salt with an acid; however, when all of R^{g}, R^{h} and Rⁱ are hydrogen atoms, the compound must form a salt, and in case where the compound does not form a salt, at least one of R^{g}, R^{h} and Rⁱ is not a hydrogen atom.

Incorporating at least one compound selected from cysteine and cysteine derivatives (b) represented by the following general formula (III), as the nucleophilic reagent (B-4) greatly improves the dispersibility of filler and therefore noticeably improves the low-heat-generation property of the rubber composition.

The nucleophilic reagent (B-4) contained in the rubber composition of the second aspect of the present invention is preferably in an amount of from 0.1 to 5 parts by mass per 100 parts by mass of the rubber component (A). The amount of 0.1 parts by mass or more can exhibit a sufficient effect of improving the dispersibility of filler, and the amount of 5 parts by mass or less does not have any significant influence on the vulcanization speed. More preferably, the amount of the nucleophilic reagent (B-4) is from 0.5 to 1 part by mass per 100 parts by mass of the rubber component (A).

### (Cysteine)

Cysteine in the rubber composition of the second aspect of the present invention is 2-amino-3-sulfanylpropionic acid, including optical isomers, L-cysteine and D-cysteine. L-cysteine, for example, one manufactured by MP Biomedicals, Inc. is available from Wako Pure Chemicals.

### (Cysteine Derivative (b))

The cysteine derivative (b) in the rubber composition of the second aspect of the present invention is a compound derived from cysteine, especially from L-cysteine, and is a compound represented by the above-mentioned general formula (III). The derivative does not include cysteine itself.

In the general formula (III), X is preferably a methylene group, an ethylene group, a propane-1,3-diyl group, a propane-1,2-diyl group, a butane-1,4-diyl group, a butane-1,3-diyl group, a butane-1,2-diyl group, a pentane-1,5-diyl group, a pentane-1,4-diyl group, a pentane-1,3-diyl group, a pentane-1,2-diyl group, a hexane-1,6-diyl group, a hexane-1,5-diyl group, a hexane-1,4-diyl group, a hexane-1,3-diyl group, or a hexane-1,2-diyl group.

Preferably, Y and Z each are independently a single bond, a methylene group, an ethylene group, a propane-1,3-diyl group, a propane-1,2-diyl group, a butane-1,4-diyl group, a butane-1,3-diyl group, a butane-1,2-diyl group, a pentane-1,5-diyl group, a pentane-1,4-diyl group, a pentane-1,3-diyl group, a pentane-1,2-diyl group, a hexane-1,6-diyl group, a hexane-1,5-diyl group, a hexane-1,4-diyl group, a hexane-1,3-diyl group, or a hexane-1,2-diyl group. Here, a single bond of Z means that the carbon atom at the center of X, Y and Z directly bonds to the nitrogen atom via a single bond. The same shall apply to the case where Y is a single bond.

In the general formula (III) where R^{g}, R^{h} and Rⁱ each are an aliphatic hydrocarbon group, preferably, the substituents each are independently a methyl group, an ethyl group, a propyl group, a butyl group, a pentyl group or a hexyl group, in the formula where the substituents each are an alicyclic hydrocarbon group, preferably, they each are independently a cyclopentyl group or cyclohexyl group, and in the formula where the substituents each are an aromatic hydrocarbon group, preferably, they each are independently a phenyl group, a benzyl group, an alkyl group-substituted phenyl group, or an alkyl group-substituted benzyl group.

In case where R^{g} is an alkali metal, preferred is lithium, sodium or potassium.

In case where R^{h} and Rⁱ each are an acyl group, preferably, the substituents each are independently an acetyl group, a propionyl group, a butyryl group, an isobutyryl group, a valeryl group, or an isovaleryl group.

The amine to form a salt with the moiety —COO includes triethylamine, pyridine, trimethylamine, tetramethylammonium, methyldiethylamine, tetraethylammonium, etc.

The acid to form a salt with the moiety —NR^{h}Rⁱ includes hydrochloric acid, sulfuric acid, phosphoric acid, sulfonic acid, carboxylic acid, boric acid, fatty acid, etc.

As specific examples of the cysteine derivative (b) represented by the general formula (III), there are mentioned the following compounds (b-1) to (b-4).

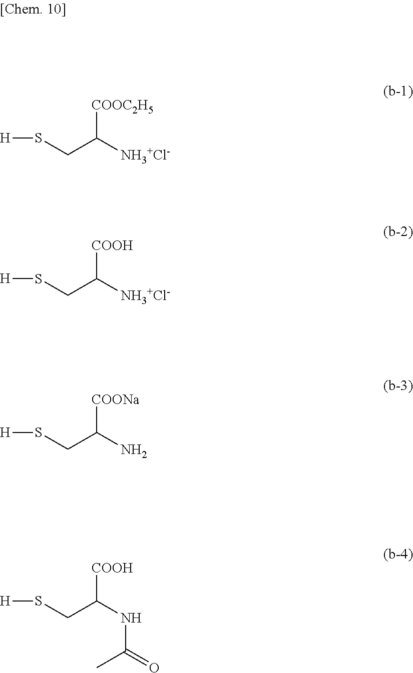

### [Guanidine Compound (B-5)]

The guanidine compound (B-5) to be contained in the rubber composition of the second aspect of the present invention includes 1,3-diphenylguanidine, 1,3-di-o-tolylguanidine, 1-o-tolylbiguanide, 1,3-di-o-cumenylguanidine, 1,3-di-o-biphenylguanidine, 1,2,3-triphenylguanidine, 2-phenyl-1,3-diphenylguanidine, 2-benzyl-1,3-di-o-cumenylguanidine, 1,3-di-o-cumenyl-2-propionylguanidine, 1,2,3-tri-o-tolylguanidine, 1,3-di-o-cumenyl-2-methylguanidine, etc. From the viewpoint of improving more the dispersibility of filler with acting together with the nucleophilic reagent (B-4), preferred is 1,3-diphenylguanidine.

The guanidine compound (B-5) to be contained in the rubber composition of the second aspect of the present invention is preferably in an amount of from 0.1 to 3 parts by mass per 100 parts by mass of the rubber component (A). The amount of 0.1 parts by mass or more can exhibit a sufficient effect of improving the dispersibility of filler, and the amount of 3 parts by mass or less does not have any significant influence on the vulcanization speed. More preferably, the amount of the guanidine compound (B-5) is from 0.5 to 1 part by mass per 100 parts by mass of the rubber component (A).

The ratio by mass of the nucleophilic reagent (B-4) to the guanidine compound (B-5) to be contained in the rubber composition of the second aspect of the present invention is preferably {nucleophilic reagent (B-4)/guanidine compound (B-5)}=(0.1/3) to (5/0.1), from the viewpoint of efficiently improving the dispersibility of filler. More preferably, the ratio by mass is from (0.5/1) to (1/0.5).

### [Phosphorous Acid Compound (B-6)]

The phosphorous acid compound (B-6) in the rubber composition of the third aspect of the present invention is represented by the above-mentioned general formula (IV). Also usable here is a salt of the phosphorous acid compound (B-6).

In case where Z¹, Z² and Z³ in the phosphorous acid compound (B-6) are carboxyl groups, the polarity of the phosphorous acid compound could be high. Accordingly, when a silane coupling agent (D) to be mentioned below is incorporated in the rubber composition, the compound of the type could readily interact with the silane coupling agent (D).

Specific examples of the phosphorous acid compound (B-6) include trihexyl phosphine, tri-n-octyl phosphine, phosphorous acid, trimethyl phosphite, triethyl phosphite, triisopropyl phosphite, triphenyl phosphite, tri-p-tolyl phosphite, tri-o-tolyl phosphite, tris(2,4-di-tert-butylphenyl)phosphite, tris(4-butylphenyl)phosphite, etc.

Salts of the phosphorous acid compound (B-6) include, for example, tris(2-carboxyethyl)phosphine hydrochloride represented by the following general formula (IV):

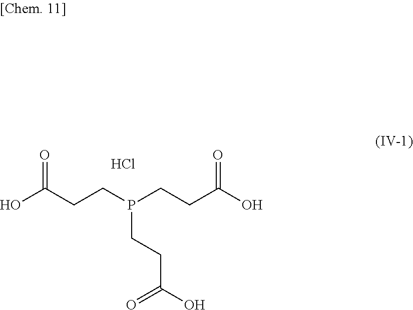

The phosphorous acid compound (B-6) enhances the activity of the coupling function of the silane coupling agent (D), therefore fully promoting the reaction between the inorganic filler (C), especially silica and the silane coupling agent (D) to realize the low-heat-generation property of the rubber composition. Regarding the amount of the phosphorous acid compound (B-6) to be in the rubber composition, preferably, the ratio by mass of {phosphorous acid compound (B-6) represented by general formula (IV)/silane coupling agent (D)} is from (2/100) to (100/100).

The amount of (2/100) or more favorably provides the reaction between the silane coupling agent (D) and the inorganic filler such as silica or the like, and the amount of (100/100) or less has little influence on the vulcanization speed. More preferably, the amount of the phosphorous acid compound (B-6) is from (4/100) to (80/100) as the ratio by mass of {phosphorous acid compound (B-6)/silane coupling agent (D)}, even more preferably from (4/100) to (50/100).

The description of the filler, the inorganic filler (C), the carbon black, the silane coupling agent (D), the vulcanizing agent, the vulcanization promoter and the organic acid compound to be given hereunder is common to the rubber composition of the first to third aspects of the present invention and also to the rubber composition production method of the first to sixth aspects of the present invention. To that effect, the matters common to the rubber composition of the first to third aspects of the present invention and also to the rubber composition production method of the first to sixth aspects of the present invention are referred to herein simply as those “of the present invention”, those “in the present invention”, or those “relating to the present invention”.

### [Filler]

Filler capable of being added to existing rubber compositions is usable as the filler in the present invention, including the inorganic filler (C).

As the filler in the present invention, the inorganic filler (C) may be used along with any other filler, or the inorganic filler (C) may be used alone.

The filler must contain the inorganic filler (C) and this is for improving the low-heat-generation property of the rubber composition.

### <Inorganic Filler (C)>

In the present invention, silica is preferred as the inorganic filler (C) from the viewpoint of satisfying both low rolling property and abrasion resistance. As silica, any commercially-available one is usable here; and above all, preferred is wet method silica, dry method silica or colloidal silica, and more preferred is wet method silica. Preferably, the BET specific surface area (as measured according to ISO 5794/1) of silica for use herein is from 40 to 350 m²/g. Silica of which the BET specific surface area falls within the range is advantageous in that it satisfies both rubber-reinforcing capability and dispersibility in rubber component. From this viewpoint, silica of which the BET specific surface area falls within a range of from 80 to 350 m²/g is more preferred, silica of which the BET specific surface area falls within a range of from more than 130 m²/g to 350 m²/g or less is even more preferred, and silica of which the BET specific surface area falls within a range of from 135 to 350 m²/g is especially preferred. As silicas of those types, usable here are commercial products of Tosoh Silica's trade names “Nipsil AQ” (BET specific surface area=205 m²/g) and “Nipsil KQ” (BET specific surface area=240 m²/g), Degussa's trade name “Ultrasil VN3” (BET specific surface area=175 m²/g), etc.

In the rubber composition containing the inorganic filler (C), especially silica therein, incorporating a compound selected from the hydroxy group-having thiourea derivative (B-1), the thioamide compound (B-2), the acidic compound (B-3), a combination of the nucleophilic reagent (B-4) except guanidine compounds and the guanidine compound (B-5), the phosphorous acid compound (B-6), the salt of the phosphorous acid compound (B-6), and the hydrazide compound (B-7) to be mentioned below greatly improves the dispersibility of the inorganic filler (C), especially silica, and therefore significantly improves the low-heat-generation property of the rubber composition.

In the rubber composition containing the inorganic filler (C), especially silica therein, it is desirable that the silane coupling agent (D) is incorporated for the purpose of increasing the ability of silica to reinforce the rubber composition or for enhancing the low-heat-generation property and also the abrasion resistance of the rubber composition.

In the rubber composition containing the inorganic filler (C), especially silica and the silane coupling agent (D) therein, it is considered that the compound selected from the hydroxy group-having thiourea derivative (B-1), the thioamide compound (B-2), the acidic compound (B-3), a combination of the nucleophilic reagent (B-4) except guanidine compounds and the guanidine compound (B-5), the phosphorous acid compound (B-6), the salt of the phosphorous acid compound (B-6), and the hydrazide compound (B-7) to be mentioned below could favorably promote the reaction between the inorganic filler (C) and the silane coupling agent (D). To that effect, in the rubber composition of the present invention, in particular, the dispersibility of silica is greatly enhanced, and therefore the low-heat-generation property of the rubber composition can be thereby significantly improved.

The details of the silane coupling agent (D) are described below.

### <Amount of Filler>

Preferably, the filler is in an amount of from 20 to 150 parts by mass per 100 parts by mass of the rubber component (A). When the amount is at least 20 parts by mass, then it is favorable from the viewpoint of improving the ability to reinforce the rubber composition; and when at most 150 parts by mass, then it is favorable from the viewpoint of reducing the rolling resistance (improving the low-heat-generation property).

Preferably, the amount of the inorganic filler (C) is from 20 to 120 parts by mass per 100 parts by mass of the rubber component. When the amount is at least 20 parts by mass, then it is favorable from the viewpoint of securing wet performance; and when at most 120 parts by mass, then it is favorable from the viewpoint of reducing the rolling resistance. Further, the amount is more preferably from 30 to 100 parts by mass.

From the viewpoint of satisfying both the wet performance and the rolling resistance reduction, preferably, the amount of the inorganic filler (C) in the filler is 30% by mass or more, more preferably 40% by mass or more, even more preferably 70% by mass or more.

In case where silica is used as the inorganic filler (C), the amount of silica to be in the filler is preferably 30% by mass or more.

The rubber composition of the present invention includes, besides silica, an inorganic compound represented by the following general formula (A).

dM¹.xSiO_{y}.zH₂O (A)

wherein in the general formula (A), M¹ represents at least one selected from a metal selected from aluminum, magnesium, titanium, calcium and zirconium, oxides and hydroxides of these metals, hydrates thereof, and carbonate salts of these metals; and d, x, y and z represent an integer of from 1 to 5, an integer of from 0 to 10, an integer of from 2 to 5 and an integer of from 0 to 10, respectively.

In the case where both x and z are 0 in the general formula (A), the inorganic compound becomes at least one metal selected from aluminum, magnesium, titanium, calcium and zirconium, or an oxide or a hydroxide of the metal.

Examples of the inorganic compound represented by the general formula (A) include alumina (Al₂O₃) such as 7-alumina and α-alumina; alumina hydrate (Al₂O₃.H₂O) such as boemite and diaspora; aluminum hydroxide (Al(OH)₃) such as gibbsite and bayerite; aluminum carbonate (Al₂(CO₃)₃); magnesium hydroxide (Mg (OH₂)); magnesium oxide (MgO); magnesium carbonate (MgCO₃); talc (3MgO.4SiO₂.H₂O); attapulgite (5MgO.8SiO₂.9H₂O); titanium white (TiO₂); titanium black (TiO₂ₙ₋₁); calcium oxide (CaO); calcium hydroxide (Ca(OH)₂); aluminum magnesium oxide (MgO.Al₂O₃); clay (Al₂O₃.2SiO₂); kaolin (Al₂O₃.2SiO₂.2H₂O); pyrophyllite (Al₂O₃.4SiO₂.H₂O); bentonite (Al₂O₃.4SiO₂.2H₂O); aluminum silicate (such as Al₂SiO₅ and Al₄.3SiO₄.5H₂O), magnesium silicate (such as Mg₂SiO₄ and MgSiO₃); calcium silicate (such as Ca₂.SiO₄); aluminum calcium silicate (such as Al₂O₃.CaO.2SiO₂); magnesium calcium silicate (CaMgSiO₄); calcium carbonate (CaCO₃); zirconium oxide (ZrO₂); zirconium hydroxide (ZrO(OH)₂.nH₂O); zirconium carbonate (Zr(CO₃)₂); crystalline aluminosilicate salts and the like containing hydrogen, an alkali metal or an alkaline earth metal, which compensates the charge, such as various kinds of zeolite.

Furthermore, at least one selected from metallic aluminum, an oxide or a hydroxide of aluminum, hydrates thereof, and aluminum carbonate, where M¹ is aluminum in the general formula (A), is preferred.

The inorganic compound represented by the general formula (A) may be used solely or as a mixture of two or more kinds thereof. The inorganic compound preferably has an average particle diameter in a range of from 0.01 to 10 μm, and more preferably in a range of from 0.05 to 5 μm, from the standpoint of the balance among the kneading processability, the abrasion resistance and the wet grip performance, and the like.

As the inorganic filler (C) in the present invention, silica may be used solely, or silica and at least one of the inorganic compound represented by the general formula (A) may be used in combination.

### <Carbon Black>

The filler of the present invention may contain carbon black depending on necessity. As carbon black, those commercially available can be used. Carbon black contained may provide an effect of decreasing the electric resistance and preventing static charge. The carbon black used is not particularly limited, and preferred examples thereof used include carbon black of the grades SAF, ISAF, IISAF, N339, HAF, FEF, GPF and SRF, with high, medium or low structure, and preferred examples among these include carbon black of the grades SAF, ISAF, IISAF, N339, HAF and FEF.

The DBP adsorption of the carbon black is preferably from 80 cm³/100 g or more, more preferably 100 cm³/100 g or more, most preferably 110 cm³/100 g or more.

The carbon black preferably has a nitrogen adsorption specific surface area of from 85 m²/g or more, more preferably 100 m²/g or more, most preferably 110 m²/g or more (N₂SA, measured according to JIS K6217-2 (2001)).

### <Silane Coupling Agent (D)>

The silane coupling agent (D) which can be used in combination with an inorganic filler (C) is preferably at least one compound selected from the group consisting of compounds represented by the following general formulae (V) to (VIII).

The following general formulae (V) to (VIII) will be described in this order below.

[Chem. 12]

(R¹O)₃₋ₚ(R²)ₚSi—R³—Sₐ—R³—Si(OR¹)₃₋ᵣ(R)ᵣ (V)

wherein R¹, plural groups of which may be the same as or different from each other, each represent a hydrogen atom, a linear, cyclic or branched alkyl group having from 1 to 8 carbon atoms, or a linear or branched alkoxyalkyl group having from 2 to 8 carbon atoms; R², plural groups of which may be the same as or different from each other, each represent a linear, cyclic or branched alkyl group having from 1 to 8 carbon atoms; R³, plural groups of which may be the same as or different from each other, each represent a linear or branched alkylene group having from 1 to 8 carbon atoms; a represents a number of from 2 to 6 in terms of average value, and p and r may be the same as or different from each other and each represent a number of from 0 to 3 in terms of average value, provided that both p and r are not 3 simultaneously.

Specific examples of the silane coupling agent (D) represented by the general formula (V) include bis(3-triethoxysilylpropyl)tetrasulfide, bis(3-trimethoxysilylpropyl)tetrasulfide, bis(3-methyldimethoxysilylpropyl)tetrasulfide, bis(2-triethoxysilylethyl)tetrasulfide, bis(3-triethoxysilylpropyl)disulfide, bis(3-trimethoxysilylpropyl)disulfide, bis(3-methyldimethoxysilylpropyl)disulfide, bis(2-triethoxysilylethyl)disulfide, bis(3-triethoxysilylpropyl)trisulfide, bis(3-trimethoxysilylpropyl)trisulfide, bis(3-methyldimethoxysilylpropyl)trisulfide, bis(2-triethoxysilylethyl)trisulfide, bis(3-monoethoxydimethylsilylpropyl)tetrasulfide, bis(3-monoethoxydimethylsilylpropyl)trisulfide, bis(3-monoethoxydimethylsilylpropyl)disulfide, bis(3-monomethoxydimethylsilylpropyl)tetrasulfide, bis(3-monomethoxydimethylsilylpropyl)trisulfide, bis(3-monomethoxydimethylsilylpropyl)disulfide, bis(2-monoethoxydimethylsilylethyl)tetrasulfide, bis(2-monoethoxydimethylsilylethyl)trisulfide and bis(2-monoethoxydimethylsilylethyl)disulfide.

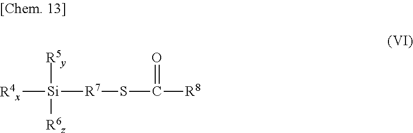

wherein R⁴ represents a monovalent group selected from —Cl, —Br, R⁹O—, R⁹C(═O)O—, R⁹R¹⁰C═NO—, R⁹R¹⁰CNO—, R⁹R¹⁰N— and —(OSiR⁹R¹⁰)ₕ(OSiR⁹R¹⁰R¹¹) (wherein R⁹, R¹⁰ and R¹¹ each represent a hydrogen atom or a monovalent hydrocarbon group having from 1 to 18 carbon atoms; and h represents a number of from 1 to 4 in terms of average value); R⁵ represents R⁴, a hydrogen atom or a monovalent hydrocarbon group having from 1 to 18 carbon atoms; R⁶ represents R⁴, R⁵, a hydrogen atom or a group represented by —(O(R¹²O)ⱼ)_{0.5} (wherein R¹² represents an alkylene group having from 1 to 18 carbon atoms; and j represents an integer of from 1 to 4); R⁷ represents a divalent hydrocarbon group having from 1 to 18 carbon atoms; R⁸ represents a monovalent hydrocarbon group having from 1 to 18 carbon atoms; and x, y and z represent numbers that satisfy relationships, x+y+2z=3, 0≦x≦3, 0≦y≦2, and 0≦z≦1.

In the general formula (VI), R⁸, R⁹, R¹⁰ and R¹¹ may be the same as or different from each other, and each preferably represent a group selected from the group consisting of a linear, cyclic or branched alkyl group having from 1 to 18 carbon atoms, an alkenyl group, an aryl group and an aralkyl group. In the case where R⁵ represents a monovalent hydrocarbon group having from 1 to 18 carbon atoms, they each preferably represent a group selected from a linear, cyclic or branched alkyl group, an alkenyl group, an aryl group and an aralkyl group. R¹² preferably represents a linear, cyclic or branched alkylene group, and particularly preferably a linear group. Examples of the group represented by R⁷ include an alkylene group having from 1 to 18 carbon atoms, an alkenylene group having from 2 to 18 carbon atoms, a cycloalkylene group having from 5 to 18 carbon atoms, a cycloalkylalkylene group having from 6 to 18 carbon atoms, an arylene group having from 6 to 18 carbon atoms and aralkylene group having from 7 to 18 carbon atoms. The alkylene group and the alkenylene group each may be linear or branched, and the cycloalkylene group, the cycloalkylalkylene group, the arylene group and the aralkylene group each may have a substituent, such as a lower alkyl group, on the ring. Preferred examples of the group represented by R⁷ include an alkylene group having from 1 to 6 carbon atoms, and particularly preferred examples thereof include a linear alkylene group, such as a methylene group, an ethylene group, a trimethylene group, a tetramethylene group, a pentamethylene group and a hexamethylene group.

Specific examples of the monovalent hydrocarbon group having from 1 to 18 carbon atoms represented by R⁵, R⁸, R⁹, R¹⁰ and R¹¹ include a methyl group, an ethyl group, a n-propyl group, an isopropyl group, a n-butyl group, an isobutyl group, a sec-butyl group, a tert-butyl group, a pentyl group, a hexyl group, an octyl group, a decyl group, a dodecyl group, a cyclopentyl group, a cyclohexyl group, a vinyl group, a propenyl group, an allyl group, a hexenyl group, an octenyl group, a cyclopentenyl group, a cyclohexenyl group, a phenyl group, a tolyl group, a xylyl group, a naphthyl group, a benzyl group, a phenethyl group and a naphthylmethyl group.

Specific examples of the group represented by R¹² in the general formula (VI) include a methylene group, an ethylene group, a trimethylene group, a tetramethylene group, a pentamethylene group, a hexamethylene group, an octamethylene group, a decamethylene group and a dodecamethylene group.

Specific examples of the silane coupling agent (D) represented by the general formula (VI) include 3-hexanoylthiopropyltriethoxysilane, 3-octanoylthiopropyltriethoxysilane, 3-decanoylthiopropyltriethoxysilane, 3-lauroylthiopropyltriethosysilane, 2-hexanoylthioethyltriethoxysilane, 2-octanoylthioethyltriethoxysilane, 2-decanoylthioethyltriethoxysilane, 2-lauroylthioethyltriethoxysilane, 3-hexanoylthiopropyltrimethoxysilane, 3-octanoylthiopropyltrimethoxysilane, 3-decanoylthiopropyltrimethoxysilane, 3-lauroylthiopropyltrimethoxysilane, 2-hexanoylthioethyltrimethoxysilane, 2-octanoylthioethyltrimethoxysilane, 2-decanoylthioethyltrimethoxysilane and 2-lauroylthioethyltrimethoxysilane. Among these, 3-octanoylthiopropyltriethoxysilane (“NXT Silane”, a trade name, produced by General Electric Silicones, Inc.) is particularly preferred.

[Chem. 14]

(R¹³O)₃₋ₛ(R¹⁴)ₛSi—R¹⁵—Sₖ—R¹⁶—Sₖ—R¹⁵—Si(OR¹³)₃₋ₜ(R¹⁴)ₜ (VII)

wherein R¹³, plural groups of which may be the same as or different from each other, each represent a hydrogen atom, a linear, cyclic or branched alkyl group having from 1 to 8 carbon atoms, or a linear or branched alkoxyalkyl group having from 2 to 8 carbon atoms; R¹⁴, plural groups of which may be the same as or different from each other, each represent a linear, cyclic or branched alkyl group having from 1 to 8 carbon atoms; R¹⁵, plural groups of which may be the same as or different from each other, each represent a linear or branched alkylene group having from 1 to 8 carbon atoms; R¹⁶ represents a divalent group selected from (—S—R¹⁷—S—), (—R¹⁸—Sₘ₁—R¹⁹—) and (—R²⁰—Sₘ₂—R²¹—Sₘ₃—R²²—) (wherein R¹⁷ to R²² each represent a divalent hydrocarbon group having from 1 to 20 carbon atoms, a divalent aromatic group or a divalent organic group containing a hetero element other than sulfur and oxygen; and m1, m2 and m3 each represent a number of 1 or more and less than 4 in terms of average value); k, plural numbers of which may be the same as or different from each other, each represent a number of from 1 to 6 in terms of average value; and s and t each represent a number of from 0 to 3 in terms of average value, provided that both s and t are not 3 simultaneously.

Specific examples of the silane coupling agent (D) represented by the general formula (VII) include compounds represented by average compositional formula (CH₃CH₂O)₃Si—(CH₂)₃—S₂—(CH₂)₆—S₂—(CH₂)₃—Si(OCH₂CH₃)₃, average compositional formula (CH₃CH₂O)₃Si—(CH₂)₃—S₂—(CH₂)₁₀—S₂—(CH₂)₃—Si(OCH₂CH₃)₃, average compositional formula (CH₃CH₂O)₃Si—(CH₂)₃—S₃—(CH₂)₆—S₃—(CH₂)₃—Si(OCH₂CH₃)₃, average compositional formula (CH₃CH₂O)₃Si—(CH₂)₃—S₄—(CH₂)₆—S₄—(CH₂)₃—Si(OCH₂CH₃)₃, average compositional formula (CH₃CH₂O)₃Si—(CH₂)₃—S—(CH₂)₆—S₂—(CH₂)₆—S—(CH₂)₃—Si(OCH₂CH₃)₃, average compositional formula (CH₃CH₂O)₃Si—(CH₂)₃—S—(CH₂)₆—S_{2.5}—(CH₂)₆—S—(CH₂)₃—Si(OCH₂CH₃)₃, average compositional formula (CH₃CH₂O)₃Si—(CH₂)₃—S—(CH₂)₆—S₄—(CH₂)₆—S—(CH₂)₃—Si(OCH₂CH₃)₃, average compositional formula (CH₃CH₂O)₃Si—(CH₂)₃—S—(CH₂)₆—S₄—(CH₂)₆—S—(CH₂)₃—Si(OCH₂CH₃)₃, average compositional formula (CH₃CH₂O)₃Si—(CH₂)₃—S—(CH₂)₁₀—S—(CH₂)₁₀—S—(CH₂)₃—Si—(OCH₂CH₃)₃, average compositional formula (CH₃CH₂O)₃Si—(CH₂)₃—S₄—(CH₂)₆—S₄—(CH₂)₆—S₄—(CH₂)₃—Si(OCH₂CH₃)₃, average compositional formula (CH₃CH₂O)₃Si—(CH₂)₃—S₂—(CH₂)₆—S₂—(CH₂)₆—S₂—(CH₂)₃—Si(OCH₂CH₃)₃, and average compositional formula (CH₃CH₂O)₃Si—(CH₂)₃—S—(CH₂)₆—S₂—(CH₂)₆—S₂—(CH₂)₆—S—(CH₂)₃—Si(OCH₂CH₃)₃.

The silane coupling agent (D) represented by the general formula (IV) may be produced, for example, by the method described in JP-A-2006-167919.

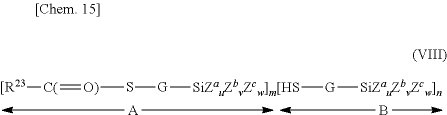

wherein R²³ represents a linear, branched or cyclic alkyl group having from 1 to 20 carbon atoms; G, plural groups of which may be the same as or different from each other, each represent an alkanediyl group or an alkenediyl group each having from 1 to 9 carbon atoms; Z^{a}, plural groups of which may be the same as or different from each other, each represent a group that is capable of being bonded to two silicon atoms and represent a functional group selected from (—O—)_{0.5}, (—O-G-)_{0.5} and (—O-G-O—)_{0.5}; Z^{b}, plural groups of which may be the same as or different from each other, each represent a group that is capable of being bonded to two silicon atoms and represent a functional group represented by (—O-G-O—)_{0.5}; Z^{c}, plural groups of which may be the same as or different from each other, each represent a functional group selected from —Cl, —Br, —OR^{x}, R^{x}C(═O)O—, R^{x}R^{y}C═NO—, R^{x}R^{y}N—, R^{x}— and HO-G-O— (wherein G agrees with the aforementioned expression); R^{x} and R^{y} each represent a linear, branched or cyclic alkyl group having from 1 to 20 carbon atoms; m, n, u, v and w satisfy 1≦m≦20, 0≦n≦20, 0≦u≦3, 0≦v≦3, 0≦w≦1, and (u/2)+v+2w=2 or 3; when there are plural moieties represented by A, Z^{a}ᵤ, Z^{b}ᵥ and Z^{c}_{w} each in the plural moieties represented by A may each be the same as or different from each other; and when there are plural moieties represented by B, Z^{a}ᵤ, Z^{b}ᵥ and Z^{c}_{w} each in the plural moieties represented by B may each be the same as or different from each other.

Specific examples of the silane coupling agent (D) represented by the general formula (VIII) include the chemical formula (IX), the chemical formula (X) and the chemical formula (XI) below.

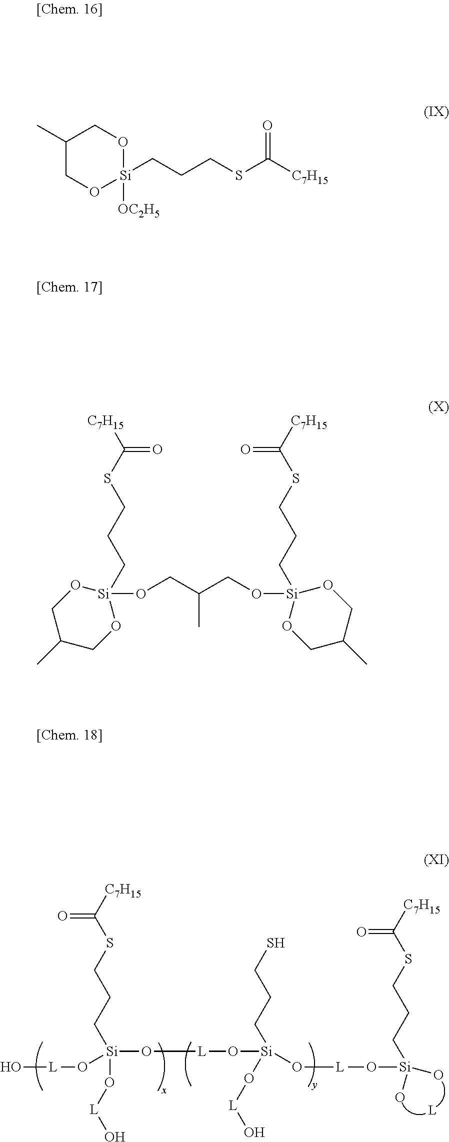

wherein L each independently represent an alkanediyl group or an alkenediyl group each having from 1 to 9 carbon atoms; x=m; and y=n.

As the silane coupling agent represented by the chemical formula (IX), “NTX Low-V Silane”, a trade name, produced by Momentive Performance Materials, Inc., is commercially available.

As the silane coupling agent represented by the chemical formula (X), “NTX Ultra Low-V Silane”, a trade name, produced by Momentive Performance Materials, Inc., is similarly commercially available.

As the silane coupling agent represented by the chemical formula (XI), “NTX-Z”, a trade name, produced by Momentive Performance Materials, Inc., may be mentioned.

The silane coupling agent (D) in the present invention is especially preferably the compound represented by the general formula (V) among the compounds represented by the general formulae (V) to (VIII). This is because the compound selected from the hydroxy group-having thiourea derivative (B-1), the thioamide compound (B-2), the acidic compound (B-3), the combination of the nucleophilic reagent (B-4) except guanidine compounds and the guanidine compound (B-5), the phosphorous acid compound (B-6) and the salt of the phosphorous acid compound (B-6) can readily activate the polysulfide bond site that reacts with the rubber component (A).

In the present invention, one alone or two or more different types of the silane coupling agents (D) may be used either singly or as combined.

The amount of the silane coupling agent (D) to be in the rubber composition of the present invention is preferably from (1/100) to (20/100) as the ratio by mass {silane coupling agent (D)/inorganic filler (C)}. When the ratio is (1/100) or more, then the rubber composition can more favorably exhibit the effect of improving the low-heat-generation property; and when (20/100) or less, then the cost of the rubber composition may lower and the economic potential thereof may increase. Further, the ratio by mass is more preferably from (3/100) to (20/100), even more preferably from (4/100) to (10/100).

In the present invention where the inorganic filler (C) such as silica or the like is incorporated in the rubber composition, preferably, the silane coupling agent (D) is incorporated in the rubber composition for the purpose of enhancing the ability of silica to reinforce the rubber composition or for the purpose of enhancing the low-heat-generation property of the rubber composition and also enhancing the abrasion resistance thereof. However, when the reaction between the inorganic filler (C) and the silane coupling agent (D) is insufficient, then the inorganic filler (C) could not fully exhibit the effect thereof to reinforce the rubber composition, and if so, the abrasion resistance of the composition may lower. Further, when the silane coupling agent that has remained unreacted in the kneading step in preparing the rubber composition reacts in the extrusion step that is carried out after the kneading step, then the extrusion-molded article of the rubber composition would be porous (that is, the article would have many foams or pores), and the accuracy of the dimension and the weight of the extrusion-molded article would be thereby lowered.

As opposed to this, when the frequency of the kneading stages in the kneading step is increased, then the reaction between the inorganic filler (C) and the silane coupling agent (D) could be finished in the kneading step and therefore the formation of the porous structure could be evaded. However, this is problematic in that the productivity in the kneading step greatly lowers.

In the rubber composition of the present invention, the compound selected from the hydroxy group-having thiourea derivative (B-1), the thioamide compound (B-2), the acidic compound (B-3), the combination of the nucleophilic reagent (B-4) except guanidine compounds and the guanidine compound (B-5), the phosphorous acid compound (B-6), the salt of the phosphorous acid compound (B-6) and the hydrazide compound (B-7) to be mentioned below favorably promotes the reaction between the inorganic filler (C) and the silane coupling agent (D), and therefore a rubber composition having an excellent low-heat-generation property can be obtained here. To that effect, according to the rubber composition of the present invention, there are provided pneumatic tires which are excellent in workability in rubber processing and have a low-heat-generation property.

In particular, the hydroxy group of the thiourea derivative (B-1) interacts with silica, therefore enhancing the reaction between the silane coupling agent and the rubber component to provide an excellent low-heat-generation property.

The total amount of the compound selected from the hydroxy group-having thiourea derivative (B-1), the thioamide compound (B-2), the acidic compound (B-3), the combination of the nucleophilic reagent (B-4) except guanidine compounds and the guanidine compound (B-5), and the hydrazide compound (B-7) to be mentioned, which is contained in the rubber composition containing the silane coupling agent (D) of the present invention, is preferably from (2/100) to (200/100) as the ratio by mass of [{hydroxy group-having thiourea derivative (B-1), thioamide compound (B-2), acidic compound (B-3), combination of nucleophilic reagent (B-4) except guanidine compounds and guanidine compound (B-5), and hydrazide compound (B-7) to be mentioned}/silane coupling agent (D)]. When the ratio is (2/100) or more, then the silane coupling agent (D) could be fully activated; and when (200/100) or less, then the compound would not have any significant influence on the vulcanization speed. The amount of the compound selected from the hydroxy group-having thiourea derivative (B-1), the thioamide compound (B-2), the acidic compound (B-3), the combination of the nucleophilic reagent (B-4) except guanidine compounds and the guanidine compound (B-5), and the hydrazide compound (B-7) to be mentioned is more preferably from (2/100) to (100/100) as the ratio by mass of [{hydroxy group-having thiourea derivative (B-1), thioamide compound (B-2), acidic compound (B-3), combination of nucleophilic reagent (B-4) except guanidine compounds and guanidine compound (B-5), and hydrazide compound (B-7) to be mentioned}/silane coupling agent (D)], even more preferably from (5/100) to (100/100).

Here, the combination of the nucleophilic reagent (B-4) except guanidine compounds and the guanidine compound (B-5) is in terms of the ratio by mass of [total of {nucleophilic reagent (B-4) and guanidine compound (B-5)}/silane coupling agent (D)].

### [Vulcanizing Agent, Vulcanization Promoter]

In the rubber composition of the present invention, incorporated are a vulcanizing agent and a vulcanization promoter. The vulcanizing agent includes sulfur, etc. Not specifically defined, the vulcanization promoter includes thiazole-type vulcanization promoters such as M (2-mercaptobenzothiazole), DM (dibenzothiazolyl disulfide), CZ (N-cyclohexyl-2-benzothiazolylsulfenamide), etc.; guanidine vulcanization promoters such as DPG (diphenylguanidine), etc.

### [Organic Acid Compound]

The organic acid compound in the present invention includes saturated fatty acids and unsaturated fatty acids such as stearic acid, palmitic acid, myristic acid, lauric acid, arachidic acid, behenic acid, lignoceric acid, capric acid, pelargonic acid, caprylic acid, enanthic acid, caproic acid, oleic acid, vaccenic acid, linolic acid, linolenic acid, nervonic acid, etc.; as well as resin acids such as rosin acid, modified rosin acid, etc.; esters of the above-mentioned saturated fatty acids and unsaturated fatty acids, esters of resin acids, etc.

In the present invention, the acid compound must exhibit the function thereof as a vulcanization promoter aid, and therefore preferably, stearic acid accounts for 50 mol % or more of the organic acid compound.

In case where an emulsion-polymerized styrene-butadiene copolymer is used as all or apart of the rubber component (A), it is desirable that 50 mol % or more of the organic acid compound is the rosin acid (including modified rosin acid) and/or fatty acid contained in the emulsion-polymerized styrene-butadiene copolymer, from the viewpoint of the emulsifying agent to be used in producing the emulsion-polymerized styrene-butadiene copolymer.

### [Production Method for Rubber Composition]

The first aspect of the present invention relating to the production method for the rubber composition of the invention is a method for producing the rubber composition that contains the rubber component (A), the hydroxy group-having thiourea derivative (B-1) represented by the general formula (I), and the filler containing the inorganic filler (C), and the method includes at least a first kneading stage of kneading the rubber component (A), the hydroxy group-having thiourea derivative (B-1), and all or a part of the inorganic filler (C), and, after the first kneading stage, a final kneading stage of adding thereto a vulcanizing agent and further kneading them.

In the above-mentioned general formula (I), the preferred embodiments of R^{a}, R^{b}, R^{c} and R^{d} are the same as those in rubber composition of the first embodiment of the first aspect of the present invention mentioned above. Especially preferably, the hydroxy group-having thiourea derivative (B-1) is one represented by the general formula (I) in which R^{a} is a functional group selected from an allyl group, an alkyl group-substituted allyl group, and an allyl group-having alkenyl group, R^{b} is a hydrogen atom, R^{c} is a functional group selected from a hydroxy group-having alkyl group, a hydroxy group-having alkenyl group and a hydroxy group-having aryl group, and R^{d} is a hydrogen atom.

From the viewpoint of bettering the dispersion of the inorganic filler (C) such as silica or the like in the rubber composition and for improving the low-heat-generation property of the rubber composition, it is desirable to add the silane coupling agent (D) in the first kneading stage.

The production method for the rubber composition of the second aspect of the present invention is a method for producing the rubber composition that contains the rubber component (A), the thioamide compound (B-2) represented by the general formula (II), the filler containing the inorganic filler (C), and the silane coupling agent (D), wherein the rubber composition is kneaded in plural stages, and in the first kneading stage (the first stage of kneading), the rubber component (A), all or a part of the inorganic filler (C), all or a part of the silane coupling agent (D), and the thioamide compound (B-2) represented by the general formula (II) are kneaded.

The production method for the rubber composition of the third aspect of the present invention is a method for producing the rubber composition that contains the rubber component (A), the acidic compound (B-3) of which the logarithmic value pKa of the reciprocal number of the acid dissociation constant Ka is 4 or less, and the filler containing the inorganic filler (C), and the method includes at least a first kneading stage of kneading the rubber component (A), the acidic compound (B-3), and all or a part of the inorganic filler (C), and, after the first kneading stage, a final kneading stage of adding thereto a vulcanizing agent and further kneading them. In this, the method for measuring pKa comprises analyzing the compound in an aqueous solution at a temperature of 25° C. with a pH measuring apparatus, and the value in the dissociation stage 1 is pKa of the compound. As the pH measuring apparatus, usable here is an ordinary commercially-available pH meter. According to the production method for the rubber composition, the dispersibility of filler is greatly increased and the low-heat-generation property of the rubber composition is significantly improved.

In the third aspect of the present invention relating to the rubber composition production method, the acidic compound (B-3) of which the logarithmic value pKa of the reciprocal number of the acid dissociation constant Ka is 4 or less may be hereinunder abbreviated as “acidic compound (B-3)”.

The third aspect of the present invention relating to the rubber composition production method may be a method that includes a first kneading stage of kneading the acidic compound (B-3) and the filler containing the inorganic filler (C), but may also be a method that includes a first stage of kneading the rubber component (A), the acidic compound (B-3), all or a part of the inorganic filler (C) and all or a part of the silane coupling; and preferably, the silane coupling agent (D) is further added to the first kneading stage.

The acidic compound (B-3) to be contained in the rubber composition in the production method of the third aspect of the present invention is preferably in an amount of from 0.1 to 5 parts by mass per 100 parts by mass of the rubber component (A). The amount of 0.1 parts by mass or more can exhibit a sufficient effect of improving the dispersibility of filler, and the amount of 5 parts by mass or less does not have any significant influence on the vulcanization speed. More preferably, the amount of the acidic compound (B-3) is from 0.5 to 3 parts by mass per 100 parts by mass of the rubber component (A).

The production method for the rubber composition of the fourth aspect of the present invention is a production method for the rubber composition that contains the rubber component (A), the nucleophilic reagent (B-4) except guanidine compounds, the guanidine compound (B-5), and the filler containing the inorganic filler (C), and the method includes a first kneading stage of kneading the rubber component (A), the nucleophilic reagent (B-4), the guanidine compound (B-5) and all or a part of the inorganic filler (C), and, after the first kneading stage, a final kneading stage of adding thereto a vulcanizing agent and further kneading them.

In the first kneading stage for the rubber composition, adding the nucleophilic reagent (B-4) and the guanidine compound (B-5) to the system further improves the dispersibility of the inorganic filler, and the low-heat-generation property of the rubber composition is thereby significantly improved.

In the rubber composition production method of the fourth aspect of the present invention, the nucleophilic reagent (B-4) is preferably at least one compound selected from cysteine and the cysteine derivative (b) represented by the general formula (III), from the viewpoint of further improving the dispersibility of the inorganic filler. More preferred is cysteine.

From the viewpoint of improving the effect of the nucleophilic reagent (B-4) and the guanidine compound (B-5) in the fourth aspect of the present invention, preferably, the organic acid compound is added to the system in the stage later than the first kneading state, for example, in the intermediate kneading stage or in the final kneading stage. More preferably the compound is added in the final kneading stage.

The rubber composition production method of the fifth aspect of the present invention is a production method for the rubber composition that contains the rubber component (A), the filler containing the inorganic filler (C), the silane coupling agent (D), and the phosphorous acid compound (B-6) represented by the general formula (IV) or the salt of the phosphorous acid compound (B-6), wherein the rubber composition is kneaded in multiple stages, and in the first kneading stage (in the first stage of kneading), the rubber component (A), all or a part of the inorganic filler (C), all or a part of the silane coupling agent (D), and the phosphorus acid compound (B-6) represented by the general formula (IV) or the salt of the phosphorous acid compound (B-6) are kneaded. According to the rubber composition production method of the fifth aspect of the present invention, it is considered that the phosphorous acid compound (B-6) could better the dispersibility of the filler containing the inorganic filler (C). To that effect, according to the rubber composition production method of the fifth aspect of the present invention, there are provided pneumatic tires which are excellent in workability in rubber processing and have a low-heat-generation property.

The rubber composition production method of the sixth aspect of the present invention is a production method for the rubber composition that contains the rubber component (A) containing at least one selected from natural rubber and synthetic dienic rubber, the filler containing the inorganic filler (C), the silane coupling agent (D) and the hydrazide compound (B-7), wherein the rubber composition is kneaded in plural stages, and in the first kneading stage (first stage of kneading), the rubber component (A), all or a part of the inorganic filler (C), all or apart of the silane coupling agent (C), and the hydrazide compound (B-7) are kneaded. According to the production method, the activity of the coupling function of the silane coupling agent can be further enhanced, and a rubber composition excellent in low-heat-generation property can be obtained.

Preferably, the hydrazide compound (B-7) is at least one hydrazide compound represented by the following general formula (XII):

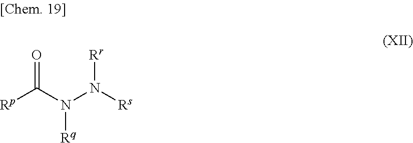

[In the formula, R^{p}, R^{q}, R^{r} and R^{s} each are independently selected from an alkyl group, an alkenyl group and a substituted aryl group, and may further have a hydrazide moiety. R^{r} and R^{s} may bond to each other to form an alkylene group.]

The hydrazide compound (B-7) represented by the general formula (XII) is preferably at least one compound selected from a group consisting of adipic acid dihydrazide, sebacic acid dihydrazide, dodecanediohydrazide, isophthalic acid dihydrazide, propionic acid hydrazide, salicylic acid hydrazide and 3-hydroxy-2-naphthoic acid hydrazide.

Above all, especially preferred is at least one compound selected from a group consisting of adipic acid dihydrazide, isophthalic acid dihydrazide, propionic acid hydrazide and 3-hydroxy-2-naphthoic acid hydrazide.

Preferably, the molecular number (molar number) of the hydrazide compound (B-7) in the rubber composition in the first kneading stage (first stage of kneading) in the rubber composition production method of the sixth aspect of the present invention is from 0.1 to 1.0 time the molecular number (molar number) of the silane coupling agent (D). The amount of 0.1 times or more sufficiently provides activation of the silane coupling agent (C); and the amount of 1.0 time or less would not have any significant influence on the vulcanization speed. More preferably, the molecular number (molar number) of the hydrazide compound (B-7) is from 0.2 to 0.6 times the molecular number (molar number) of the silane coupling agent (D).

Embodiments of the production method that are common to the rubber composition production method of the first to sixth aspects of the present invention are described below.

In the following description, the compound selected from the hydroxy group-having thiourea derivative (B-1) in the production method of the first aspect of the present invention, the thioamide compound (B-2) in the production method of the second aspect of the present invention, the acidic compound (B-3) in the production method of the third aspect of the present invention, the combination of the nucleophilic reagent (B-4) except guanidine compounds and the guanidine compound (B-5) in the production method of the fourth aspect of the present invention, the phosphorous acid compound (B-6) or the salt of the phosphorous acid compound (B-6) in the production method of the fifth aspect of the present invention, and the hydrazide compound (B-7) in the production method of the sixth aspect of the present invention is abbreviated as “compound X”.

In the rubber composition production method of the first to sixth aspects of the present invention, for bettering the dispersion of the inorganic filler (C) such as silica or the like in the rubber composition, preferably, the maximum temperature of the rubber composition in the first kneading stage of kneading the rubber component (A), the compound X and all or a part of the inorganic filler (C) is from 120 to 190° C., more preferably from 130 to 175° C., even more preferably from 140 to 170° C.

The kneading time in the first kneading stage is preferably from 10 seconds to 20 minutes, more preferably from 10 seconds to 10 minutes, even more preferably from 30 seconds to 5 minutes.

In the first kneading step in the rubber composition production method of the first to sixth aspects of the present invention, preferably, the compound X is added in a ratio by mass {compound X/silane coupling agent (D)} of form (2/100) to (200/100). The amount of (2/100) or more fully provides the activation of the silane coupling agent (D), and the amount of (200/100) or less would not have any significant influence on the vulcanization speed. More preferably, the compound X is added in a ratio by mass {compound X/silane coupling agent (D)} of form (2/100) to (100/100), even more preferably from (5/100) to (100/100).

Here, in case where the compound X is the combination of the nucleophilic reagent (4) except guanidine compounds and the guanidine compound (B-5), the mass of the compound X is the total amount of the nucleophilic reagent (B-4) and the guanidine compound (B-5).

However, in the case of the phosphorous acid compound (B-6), the phosphorous acid compound (B-6) to be incorporated is more preferably in a ratio by mass {phosphorous acid compound (B-6)/silane coupling agent (D) of from (4/100) to (80/100), more preferably from (4/100) to (50/100).

In the method of putting the compound X into the system in the first kneading stage in the rubber composition production method of the first to sixth aspects of the present invention, in which the rubber composition contains the inorganic filler (C) and the silane coupling agent (D), preferably, the compound X is added thereto after the rubber component (A), all or a part of the inorganic filler (C) and all or a part of the silane coupling agent have been kneaded, and the resulting composition is further kneaded. This is because, according to the adding method of the type, the reaction between the silane coupling agent (D) and the rubber component (A) can be promoted after the reaction between the silane coupling agent (D) and silica has sufficiently run on, and therefore the dispersibility of the inorganic filler (C) can be further improved.

The time to be taken until the compound X is added during the course of the first kneading stage after the rubber component (A), all or a part of the inorganic filler (C) and all or a part of the silane coupling agent (D) have been added in the first kneading stage in the present invention, is preferably from 10 to 180 seconds. More preferably, the upper limit of the time is 150 seconds or less, even more preferably 120 seconds or less. Within the time of 10 seconds or more, the reaction between the inorganic filler (C) and the silane coupling agent (D) can be sufficiently promoted. Even though the time is over 180 seconds, no one could hardly enjoy any additional effect since the reaction between the inorganic filler (C) and the silane coupling agent (D) has already been sufficiently promoted, and consequently, the upper limit is preferably 180 seconds.

The rubber composition in the rubber composition production method of the first to sixth aspects of the present invention is prepared mainly by kneading the rubber component (A) and the inorganic filler (C), and in general, the composition is prepared in two stages of a master batch kneading stage that is a step before incorporation of a vulcanizing agent and a vulcanization promoter thereinto, and a final kneading stage of incorporating the vulcanizing agent and the vulcanization promoter to prepare a vulcanizable rubber composition.

The above-mentioned first kneading stage corresponds to the master batch kneading stage in this embodiment. Specifically, the first kneading stage in the present invention is a stage in which the composition does not contain any vulcanization chemical. Here, the vulcanization chemical is meant to indicate a chemical relating to vulcanization, concretely including a vulcanizing agent and a vulcanization promoter. The first kneading stage in the present invention is the first stage of kneading the rubber component (A), the compound X, and the filer containing the inorganic filler (C), and does not include a case of kneading the rubber component (A) and the filler except the inorganic filler (C) in the first stage and a case of pre-kneading the rubber component (A) alone.

Between the first kneading stage and the final kneading stage, the production method may include an intermediate kneading stage mainly for lowering the viscosity of the master batch.

In the master batch kneading stage in the rubber composition production method of the first to sixth aspects of the present invention, at least the rubber component (A), the compound X, all or a part of the inorganic filler (C) and all or a part of the silane coupling agent (D) may be kneaded and the alcohol such as ethanol or the like and the other volatile organic component that are produced during the reaction between the inorganic filler (C) and the silane coupling agent (D) can be evaporated away during the kneading operation. Accordingly, it is possible to prevent alcohol and others from being evaporated away in the extrusion step to be carried out after the master batch kneading step, and it is therefore possible to prevent a porous structure from being formed in the extrusion-molded article.

In case where a master batch could hardly be produced in one master batch kneading stage, or if desired, the master batch kneading stage may be divided into a first master batch kneading stage and a second master batch kneading stage (intermediate kneading stage).

For example, in the first kneading stage (or that is, in the master batch kneading stage), the rubber component (A), all or a part of the inorganic filler (C) and all or a part of the silane coupling agent (D) may be kneaded as the first master batch kneading stage, then the resulting mixture is spontaneously cooled and aged, and thereafter the compound X may be added thereto as the second master batch kneading stage.

In the intermediate kneading stage such as the second master batch kneading stage or the like, the rubber component, the filler and others may be added and kneaded.

In case where the production method includes the intermediate kneading stage after the first kneading stage and before the final kneading stage, the maximum temperature of the rubber composition in the intermediate kneading stage is preferably from 120 to 190° C., more preferably from 130 to 175° C., even more preferably from 140 to 170° C. The kneading time is preferably from 10 seconds to 20 minutes, more preferably from 10 seconds to 10 minutes, even more preferably from 30 seconds to 5 minutes. In case where the production method includes the intermediate kneading stage, it is desirable that the rubber composition is processed in the next stage after the temperature thereof is lowered by 10° C. or more than the temperature after the kneading in the previous stage.

The final kneading stage is a step of adding the vulcanization chemical (vulcanizing agent, vulcanization promoter) and kneading the composition. The maximum temperature of the rubber composition in the final kneading stage is preferably from 60 to 140° C., more preferably from 80 to 120° C., even more preferably from 100 to 120° C. The kneading time is preferably from 10 seconds to 20 minutes, preferably from 10 seconds to 10 minutes, more preferably from 20 seconds to 5 minutes.

When the composition is processed in the first kneading stage, the intermediate kneading stage and the final kneading stage in that order, it is desirable that the temperature of the composition is lowered by 10° C. or more than the temperature thereof after kneading in the previous kneading stage.

In the rubber composition production method of the first to sixth aspects of the present invention, in general, various additives, for example, a vulcanization activator, an antiaging agent or the like such as stearic acid, zinc oxide and others to be incorporated in the rubber composition may be, if desired, kneaded in the composition in the master batch kneading stage or the final kneading stage, or in the above-mentioned intermediate kneading stage.

In the present invention, the rubber composition is kneaded with a Banbury mixer, a roll, an intensive mixer or the like. Afterwards, the composition is extruded and worked in the subsequent extrusion step and is thus formed as tread members. Subsequently, this is stuck and shaped according to an ordinary method using a tire forming machine, thereby forming an unvulcanized tire. The unvulcanized tire is heated under pressure in a vulcanizing machine to give a tire. In the present invention, the tread means the cap tread to constitute the grounding part of a tire and/or a base tread to be arranged inside the cap tread.

### EXAMPLES

The present invention is described in more detail with reference to the following Examples; however, the present invention is not limited at all by the following Examples.

### [Evaluation Methods]

### <Low-Heat-Generation Property (tan δ Index) in Tables 1 to 7>

Using a viscoelasticity measuring device (by Rheometric), tan δ of the rubber composition sample was measured at a temperature of 60° C., at a dynamic strain of 5% and at a frequency of 15 Hz. Based on the reciprocal number of the tan δ in Comparative Example 1, 9, 11, 16, 21, 28 or 35, as referred to 100, the data were expressed as index indication according to the following formula. The samples having a larger index value have a better low-heat-generation property and have a smaller hysteresis loss.

Low Heat-Generation Index={(tan δ of vulcanized rubber composition in Comparative Example 1, 9, 11, 16, 21, 28 or 35)/(tan δ of vulcanized rubber composition tested)}×100

<Low-Heat-Generation Property (tan δ index) in Table 8>

Using a spectrometer (by Ueshima Seisakusho), tan δ of the rubber composition sample was measured at a frequency of 52 Hz, at an initial strain of 10%, at a temperature of 60° C. and at a dynamic strain of 1%. Based on the tan δ in Comparative Example 43, as referred to 100, the data were expressed as index indication according to the following formula. The samples having a smaller index value have a better low-heat-generation property and have a smaller hysteresis loss.

Low Heat-Generation Index={(tan δ of vulcanized rubber composition tested)/(tan δ of vulcanized rubber composition in Comparative Example 43)}×100

Note] The index value indicating the low-heat-generation property (tan δ index) in Table 8 and the index value indicating the low-heat-generation property (tan δ index) in Tables 1 to 7 bear a reciprocal relationship to each other.

### <Abrasion Resistance (Index) in Table 1 and Table 8>

According to JIS K 6264-2:2005 and using a Lambourn abrasion tester, the depth of wear was measured at room temperature (23° C.) and under the condition of a slip ratio 25%. Based on the reciprocal of the depth of wear in Comparative Example 1 or 43, as referred to 100, the data were expressed as index indication according to the following formula. The samples having a larger index value have better abrasion resistance.

Abrasion Resistance Index={(depth of wear of vulcanized rubber composition of Comparative Example 1 or 43)/(depth of wear of vulcanized rubber composition tested)}×100

### <Abrasion Resistance (Index) in Table 2 and Table 7>

The tire to be tested was put on a passenger car, and at the time when the car was driven for 10,000 km, the depth of wear of the tire was measured. Based on the depth of wear of the tire in Comparative Example 9 or 35, as referred to 100, the data were expressed as index indication according to the following formula. The samples having a larger index value have better abrasion resistance.

(Depth of wear of sample in Comparative Example 9 or 35)/(depth of wear of tested sample)}×100

### Production Example 1

### Production of Silane Coupling Agent Represented by Mean Compositional Formula (CH₃CH₂O)₃Si—(CH₂)₃—S—(CH₂)₆—S_{2.5}—(CH₂)₆—S—(CH₂)₃—Si(OCH₂CH₃)₃

119 g (0.5 mol) of 3-mercaptopropyltriethoxysilane was put into a 2-liter separable flask equipped with a nitrogen gas introducing duct, a thermometer, a Dimroth condenser and a dropping funnel, and with stirring, and 151.2 g (0.45 mol) of an ethanol solution of sodium ethoxide having an active ingredient concentration of 20% by mass was added thereto. Subsequently, this was heated up to 80° C. and kept stirred for 3 hours. Afterwards, this was cooled and transferred into the dropping funnel.

Next, 69.75 g (0.45 mol) of 1,6-dichlorohexane was put into the same type of a separable flask as above, heated up to 80° C., and then the reaction product of the above-mentioned 3-mercaptopropyltriethoxysilane and sodium ethoxide was slowly and dropwise added thereto. After the addition, this was kept stirred at 80° C. for 5 hours. Subsequently, this was cooled, then the salt was separated through filtration from the resulting solution, and further ethanol and the excessive 1,6-dichlorohexane were evaporated away under reduced pressure. The resulting solution was vaporized under reduced pressure to give 137.7 g of a colorless transparent liquid having a boiling point of 148 to 150° C./0.005 Torr (0.67 Pa). As a result of IR analysis, ¹H-NMR analysis and mass spectrometry (MS analysis) thereof, the product was a compound represented by (CH₃CH₂O)₃Si—(CH₂)₃S—(CH₂)₆—Cl. The purity through gas chromatography (GC analysis) was 97.5%.

Next, 80 g of ethanol, 5.46 g (0.07 mol) of anhydrous sodium sulfide and 3.36 g (0.105 mol) of sulfur were put into a 0.5-ml separable flask of the same type as above, and heated up to 80° C. With stirring this solution, 49.94 g (0.14 mol) of the above-mentioned (CH₃CH₂O)₃Si—(CH₂)₃S—(CH₂)₆—Cl was slowly and dropwise added thereto. After the addition, this was kept stirred at 80° C. for 10 hours. After the stirring, this was cooled, the formed salt was through filtration, and the solvent ethanol was evaporated away under reduced pressure.

The obtained, red-brownish transparent solution was analyzed through IR analysis, ¹H-NMR analysis and supercritical chromatography, and as a result, the product was identified as a compound represented by (CH₃CH₂O)₃Si—(CH₂)₃—S—(CH₂)₆—S_{2.5}—(CH₂)₆—S—(CH₂)₃—Si(OCH₂CH₃)₃. The purity of the compound in GPC analysis was 85.2%.

### Production Example 2

### Synthesis Method for 2-Hydroxyethyl-thiourea

A dichloromethane (10 L) solution of 2-ethanolamine (61 g, 1.0 mol) and thiocarbonyldiimidazole (TCDI, 200 g, 1.2 mol) was stirred at room temperature for 2 hours. An aqueous 25% ammonia solution (2.0 L, excessive amount) was added thereto, and the reaction mixture was kept stirred overnight at room temperature. The solvent was removed, and the resulting residue was purified through silica gel chromatography using methanol and dichloromethane as eluents to give a white solid. As a result of IR analysis, ¹H-NMR analysis and mass spectrometry (MS analysis) thereof, the product was a compound, 2-hydroxyethyl-thiourea (111 g, 0.93 mol, yield 93%).

### Production Example 3

### Synthesis Method for 3-Hydroxypropyl-thiourea

A dichloromethane (10 L) solution of 3-propanolamine (75 g, 1.0 mol) and thiocarbonyldiimidazole (TCDI, 200 g, 1.2 mol) was stirred at room temperature for 2 hours. An aqueous 25% ammonia solution (2.0 L, excessive amount) was added thereto, and the reaction mixture was kept stirred overnight at room temperature. The solvent was removed, and the resulting residue was purified through silica gel chromatography using methanol and dichloromethane as eluents to give a white solid. As a result of IR analysis, ¹H-NMR analysis and mass spectrometry (MS analysis) thereof, the product was a compound, 3-hydroxypropyl-thiourea (123 g, 0.92 mol, yield 92%).

### Examples 1 to 12

In the first kneading stage in kneading, a rubber component (A), a hydroxy group-having thiourea derivative (B-1), carbon black, an inorganic filler (C), a silane coupling agent (D), aromatic oil, stearic acid and an antiaging agent 6PPD were kneaded in a Banbury mixer, and the maximum temperature of the rubber composition in the first kneading stage was controlled to be 150° C.

Next, in the final stage of kneading, the remaining components shown in Table 1 were added and kneaded, and the maximum temperature of the rubber composition in the final kneading stage was controlled to be 110° C.

The low-heat-generation property (tan δ index) and the abrasion resistance of the vulcanized rubber composition obtained from the above rubber composition were evaluated according to the above-mentioned methods. The results are shown in Table 1.

### Example 13

The components were kneaded in the same manner as in Examples 1 to 12 except that the hydroxy group-having thiourea derivative (B-1) was not added in the first kneading stage but was added in the final kneading stage. The low-heat-generation property (tan δ index) and the abrasion resistance of the thus-obtained, vulcanized rubber composition were evaluated according to the above-mentioned methods. The results are shown in Table 1.

### Example 14

In the first kneading stage in kneading, a rubber component (A), carbon black, an inorganic filler (C), a silane coupling agent (D), aromatic oil, stearic acid and an antiaging agent 6PPD were kneaded for 60 seconds and then, a hydroxy group-having thiourea derivative (B-1) was added thereto and further kneaded. The maximum temperature of the rubber composition in the first kneading stage was controlled to be 150° C.

Next, in the final stage of kneading, the remaining components shown in Table 1 were added and kneaded, and the maximum temperature of the rubber composition in the final kneading stage was controlled to be 110° C.

The low-heat-generation property (tan δ index) and the abrasion resistance of the vulcanized rubber composition obtained from the above rubber composition were evaluated according to the above-mentioned methods. The results are shown in Table 1.

### Comparative Examples 1 to 8

The components were kneaded in the same manner as in Examples 1 to 12 except that the hydroxy group-having thiourea derivative (B-1) was not added in the first kneading stage (in the first stage of kneading). The low-heat-generation property (tan δ index) and the abrasion resistance of the thus-obtained, vulcanized rubber composition were evaluated according to the above-mentioned methods. The results are shown in Table 1.

TABLE 1

| | | | Example | | | | | | | | | | | |
|---|---|---|---|---|---|---|---|---|---|---|---|---|---|---|
| | | Components (part by mass) | 1 | 2 | 3 | 4 | 5 | 6 | 7 | 8 | 9 | 10 | 11 | 12 |
| Components | First | SBR *1 | 100 | 100 | 100 | 100 | 100 | 100 | 50 | 50 | 50 | 100 | 100 | 100 |
| of Rubber | Kneading | Natural Rubber *2 | — | — | — | — | — | — | 50 | 50 | 50 | — | — | — |
| Composition | Stage | Carbon Black-1 N220 *3 | 10 | 10 | 10 | 10 | 10 | 10 | 10 | 10 | 10 | 10 | 10 | 10 |
| | | Silica *4 | 50 | 50 | 50 | 50 | 50 | 50 | 50 | 50 | 50 | 50 | 50 | 50 |
| | | Silane Coupling Agent-1 *5 | 5 | 5 | 5 | 5 | 5 | 5 | 5 | 5 | 5 | — | — | — |
| | | Silane Coupling Agent-2 *6 | — | — | — | — | — | — | — | — | — | 5 | — | — |
| | | Silane Coupling Agent-3 *7 | — | — | — | — | — | — | — | — | — | — | 5 | — |
| | | Silane Coupling Agent-4 *8 | — | — | — | — | — | — | — | — | — | — | — | 5 |
| | | Thiourea Derivative | 0.25 | 0.5 | 1 | 2 | — | — | 1 | — | — | 1 | 1 | 1 |
| | | (B)-(a) *9 | | | | | | | | | | | | |
| | | Thiourea Derivative | — | — | — | — | 1 | — | — | 1 | — | — | — | — |
| | | (B)-(b) *10 | | | | | | | | | | | | |
| | | Thiourea Derivative | — | — | — | — | — | 1 | — | — | 1 | — | — | — |
| | | (B)-(c) *11 | | | | | | | | | | | | |
| | | Aromatic Oil | 30 | 30 | 30 | 30 | 30 | 30 | 30 | 30 | 30 | 30 | 30 | 30 |
| | | Stearic Acid | 2 | 2 | 2 | 2 | 2 | 2 | 2 | 2 | 2 | 2 | 2 | 2 |
| | | Antiaging Agent | 1 | 1 | 1 | 1 | 1 | 1 | 1 | 1 | 1 | 1 | 1 | 1 |
| | | 6PPD *12 | | | | | | | | | | | | |
| | Final | Thiourea Derivative | — | — | — | — | — | — | — | — | — | — | — | — |
| | Kneading | (B)-(a) *9 | | | | | | | | | | | | |
| | Stage | Zinc oxide | 2.5 | 2.5 | 2.5 | 2.5 | 2.5 | 2.5 | 2.5 | 2.5 | 2.5 | 2.5 | 2.5 | 2.5 |
| | | Antiaging Agent | 1 | 1 | 1 | 1 | 1 | 1 | 1 | 1 | 1 | 1 | 1 | 1 |
| | | TMDQ *13 | | | | | | | | | | | | |
| | | Vulcanization Promoter | 0.6 | 0.6 | 0.6 | 0.6 | 0.6 | 0.6 | 0.6 | 0.6 | 0.6 | 0.6 | 0.6 | 0.6 |
| | | DPG *14 | | | | | | | | | | | | |
| | | Vulcanization Promoter | 1 | 1 | 1 | 1 | 1 | 1 | 1 | 1 | 1 | 1 | 1 | 1 |
| | | MBTS *15 | | | | | | | | | | | | |
| | | Vulcanization Promoter | 0.6 | 0.6 | 0.6 | 0.6 | 0.6 | 0.6 | 0.6 | 0.6 | 0.6 | 0.6 | 0.6 | 0.6 |
| | | TBBS *16 | | | | | | | | | | | | |
| | | Sulfur | 1.5 | 1.5 | 1.5 | 1.5 | 1.5 | 1.5 | 1.5 | 1.5 | 1.5 | 1.5 | 1.5 | 1.5 |

| | | | | | | | | | | | | | |
|---|---|---|---|---|---|---|---|---|---|---|---|---|---|
| Properties of | Low-Heat-Generation | 119 | 122 | 125 | 126 | 118 | 117 | 120 | 115 | 114 | 118 | 117 | 120 |
| Vulcanized Rubber | Properly | | | | | | | | | | | | |
| | (tanδ index) | | | | | | | | | | | | |
| | Abrasion Resistance | 104 | 105 | 106 | 107 | 102 | 103 | 105 | 103 | 104 | 95 | 105 | 103 |
| | Index | | | | | | | | | | | | |

| | | | Example | | Comparative Example | | | | | | | |
|---|---|---|---|---|---|---|---|---|---|---|---|---|
| | | Components (part by mass) | 13 | 14 | 1 | 2 | 3 | 4 | 5 | 6 | 7 | 8 |
| Components | First | SBR *1 | 100 | 100 | 100 | 50 | 100 | 50 | 100 | 50 | 100 | 50 |
| of Rubber | Kneading | Natural Rubber *2 | — | — | — | 50 | — | 50 | — | 50 | — | 50 |
| Composition | Stage | Carbon Black-1 N220 *3 | 10 | 10 | 10 | 10 | 10 | 10 | 10 | 10 | 10 | 10 |
| | | Silica *4 | 50 | 50 | 50 | 50 | 50 | 50 | 50 | 50 | 50 | 50 |
| | | Silane Coupling Agent-1 *5 | 5 | 5 | 5 | 5 | — | — | — | — | — | — |
| | | Silane Coupling Agent-2 *6 | — | — | — | — | 5 | 5 | — | — | — | — |
| | | Silane Coupling Agent-3 *7 | — | — | — | — | — | — | 5 | 5 | — | — |
| | | Silane Coupling Agent-4 *8 | — | — | — | — | — | — | — | — | 5 | 5 |
| | | Thiourea Derivative | — | 1 | — | — | — | — | — | — | — | — |
| | | (B)-(a) *9 | | | | | | | | | | |
| | | Thiourea Derivative | — | — | — | — | — | — | — | — | — | — |
| | | (B)-(b) *10 | | | | | | | | | | |
| | | Thiourea Derivative | — | — | — | — | — | — | — | — | — | — |
| | | (B)-(c) *11 | | | | | | | | | | |
| | | Aromatic Oil | 30 | 30 | 30 | 30 | 30 | 30 | 30 | 30 | 30 | 30 |
| | | Stearic Acid | 2 | 2 | 2 | 2 | 2 | 2 | 2 | 2 | 2 | 2 |
| | | Antiaging Agent | 1 | 1 | 1 | 1 | 1 | 1 | 1 | 1 | 1 | 1 |
| | | 6PPD *12 | | | | | | | | | | |
| | Final | Thiourea Derivative | 1 | — | — | — | — | — | — | — | — | — |
| | Kneading | (B)-(a) *9 | | | | | | | | | | |
| | Stage | Zinc oxide | 2.5 | 2.5 | 2.5 | 2.5 | 2.5 | 2.5 | 2.5 | 2.5 | 2.5 | 2.5 |
| | | Antiaging Agent | 1 | 1 | 1 | 1 | 1 | 1 | 1 | 1 | 1 | 1 |
| | | TMDQ *13 | | | | | | | | | | |
| | | Vulcanization Promoter | 0.6 | 0.6 | 0.6 | 0.6 | 0.6 | 0.6 | 0.6 | 0.6 | 0.6 | 0.6 |
| | | DPG *14 | | | | | | | | | | |
| | | Vulcanization Promoter | 1 | 1 | 1 | 1 | 1 | 1 | 1 | 1 | 1 | 1 |
| | | MBTS *15 | | | | | | | | | | |
| | | Vulcanization Promoter | 0.6 | 0.6 | 0.6 | 0.6 | 0.6 | 0.6 | 0.6 | 0.6 | 0.6 | 0.6 |
| | | TBBS *16 | | | | | | | | | | |
| | | Sulfur | 1.5 | 1.5 | 1.5 | 1.5 | 1.5 | 1.5 | 1.5 | 1.5 | 1.5 | 1.5 |

| | | | | | | | | | | | |
|---|---|---|---|---|---|---|---|---|---|---|---|
| Properties of | Low-Heat-Generation | 110 | 127 | 100 | 101 | 105 | 106 | 106 | 107 | 104 | 105 |
| Vulcanized Rubber | Properly | | | | | | | | | | |
| | (tanδ index) | | | | | | | | | | |
| | Abrasion Resistance | 102 | 107 | 100 | 101 | 92 | 93 | 100 | 101 | 98 | 99 |
| | Index | | | | | | | | | | |

[Notes]
The following *1 to *16 are for Table 1.
*1 Asahi Kasei's solution-polymerized SBR, product name “Toughden 2000”
*2 RSS#3
*3 N220 (ISAF), by Asahi Carbon, product name “#80”
*4 Tosoh Silica's product name “Nipsil AQ”, having BET surface area of 205 m²/g
*5 Bis(3-triethoxysilylpropyl) disulfide(mean sulfur chain length: 2.35), Evonik's silane coupling agent, product name “Si75” ®
*6 3-Octanoylthiopropyltriethoxysilane, by Momentive Performance Materials, product name “NXT Silane” ®
*7 Silane coupling agent represented by chemical formula (VII), by Momentive Performance Materials, product name “NXT-Z” ®
*8 Silane coupling agent obtained in Production Example 1 (CH₃CH₂O)₃Si—(CH₂)₃—S—(CH₂)₆—S_{2.5}—(CH₂)₆—S—(CH₂)₃—Si(OCH₂CH₃)₃
*9 Thiourea derivative (B-1)-(a): 1-allyl-3-(2-hydroxyethyl)-2-thiourea, by Tokyo Chemical Industry, product name “1-Allyl-3-(2-Hydroxyethyl)-2-Thiourea”
*10: Thiourea derivative (B-1)-(b): 2-hydroxyethyl-thiourea obtained in Production Example 2
*11: Thiourea derivative (B-1)-(c): 3-hydroxypropyl-thiourea obtained in Production Example 3
*12 N-(1,3-dimethylbutyl)-N′-phenyl-p-phenylenediamine, by Ouchi Shinko Chemical Industry, product name “Nocrac 6C”
*13 2,2,4-Trimethyl-1,2-dihydroquinoline polymer, by Ouchi Shinko Chemical Industry, product name “Nocrac 224”
*14 1,3-Diphenylguanidine, by Sanshin Chemical Industry, product name “Sanceler D”
*15 Di-2-benzothiazolyl Disulfide, by Sanshin Chemical Industry, product name “Sanceler DM”
*16 N-tert-butyl-2-benzothiazolylsulfenamide, by Sanshin Chemical Industry, product name “Sanceler NS”

As obvious from Table 1, the rubber compositions of Examples 1 to 14 all have a good low-heat-generation property (tan δ index) and good abrasion resistance, as compared with the comparative rubber compositions of Comparative Examples 1 to 8.

### Examples 15 to 23

In the first kneading stage in kneading, a rubber component (A), a thioamide compound (B-2), carbon black, an inorganic filler (C), a silane coupling agent (D), aromatic oil, stearic acid and an antiaging agent 6PPD were kneaded in a Banbury mixer, and the maximum temperature of the rubber composition in the first kneading stage was controlled to be 150° C. Next, in the final stage of kneading, the remaining components shown in Table 2 were added and kneaded, and the maximum temperature of the rubber composition in the final kneading stage was controlled to be 110° C.

The low-heat-generation property (tan δ index) and the abrasion resistance of the vulcanized rubber composition obtained from the above rubber composition were evaluated according to the above-mentioned methods. The results are shown in Table 2.

### Comparative Examples 9 to 10

The components were kneaded in the same manner as in Examples 15 to 23 except that the thioamide compound (B-2) was not added in the first kneading stage. The low-heat-generation property (tan δ index) and the abrasion resistance of the thus-obtained, vulcanized rubber composition were evaluated according to the above-mentioned methods. The results are shown in Table 2.

TABLE 2

| | Comparative | | | | | | | | | | |
|---|---|---|---|---|---|---|---|---|---|---|---|
| Components | Example | | Example | | | | | | | | |
| (part by weight) | 9 | 10 | 15 | 16 | 17 | 18 | 19 | 20 | 21 | 22 | 23 |
| SBR *1 | 100 | 50 | 100 | 100 | 100 | 100 | 100 | 100 | 50 | 50 | 50 |
| Natural Rubber *2 | 0 | 50 | 0 | 0 | 0 | 0 | 0 | 0 | 50 | 50 | 50 |
| Carbon Black-1 N220 *3 | 10 | 10 | 10 | 10 | 10 | 10 | 10 | 10 | 10 | 10 | 10 |
| Silica *4 | 50 | 50 | 50 | 50 | 50 | 50 | 50 | 50 | 50 | 50 | 50 |
| Silane Coupling Agent | 5 | 5 | 5 | 5 | 5 | 5 | 5 | 5 | 5 | 5 | 5 |
| Si75 *5 | | | | | | | | | | | |
| Compound (B)-(a) *6 | 0 | 0 | 0.25 | 0.5 | 1 | 2 | 0 | 0 | 1 | 0 | 0 |
| Compound (B)-(b) *7 | 0 | 0 | 0 | 0 | 0 | 0 | 1 | 0 | 0 | 1 | 0 |
| Compound (B)-(c) *8 | 0 | 0 | 0 | 0 | 0 | 0 | 0 | 1 | 0 | 0 | 1 |
| Aromatic Oil | 30 | 30 | 30 | 30 | 30 | 30 | 30 | 30 | 30 | 30 | 30 |
| Stearic Acid | 2 | 2 | 2 | 2 | 2 | 2 | 2 | 2 | 2 | 2 | 2 |
| Vulcanization Promoter | 0.6 | 0.6 | 0.6 | 0.6 | 0.6 | 0.6 | 0.6 | 0.6 | 0.6 | 0.6 | 0.6 |
| DPG *9 | | | | | | | | | | | |
| Antiaging Agent | 1 | 1 | 1 | 1 | 1 | 1 | 1 | 1 | 1 | 1 | 1 |
| TMDQ *10 | | | | | | | | | | | |
| Zinc oxide | 2.5 | 2.5 | 2.5 | 2.5 | 2.5 | 2.5 | 2.5 | 2.5 | 2.5 | 2.5 | 2.5 |
| Antiaging Agent | 1 | 1 | 1 | 1 | 1 | 1 | 1 | 1 | 1 | 1 | 1 |
| 6PPD *11 | | | | | | | | | | | |
| Vulcanization Promoter | 1 | 1 | 1 | 1 | 1 | 1 | 1 | 1 | 1 | 1 | 1 |
| MBTS *12 | | | | | | | | | | | |
| Vulcanization Promoter | 0.6 | 0.6 | 0.6 | 0.6 | 0.6 | 0.6 | 0.6 | 0.6 | 0.6 | 0.6 | 0.6 |
| TBBS *13 | | | | | | | | | | | |
| Sulfur | 1.5 | 1.5 | 1.5 | 1.5 | 1.5 | 1.5 | 1.5 | 1.5 | 1.5 | 1.5 | 1.5 |
| Properties of | 100 | 101 | 116 | 118 | 119 | 120 | 120 | 117 | 115 | 119 | 116 |
| Vulcanized Rubber: | | | | | | | | | | | |
| low-heat-generation | | | | | | | | | | | |
| property | | | | | | | | | | | |
| (tanδ index) | | | | | | | | | | | |
| Properties of | 100 | 103 | 101 | 102 | 103 | 104 | 104 | 102 | 105 | 107 | 106 |
| Vulcanized Rubber: | | | | | | | | | | | |
| abrasion resistance | | | | | | | | | | | |
| index | | | | | | | | | | | |

[Notes]
The following *1 to *13 are for Table 2.
*1 Asahi Kasei's solution-polymerized SBR, product name “T2000”
*2 JSR's RSS#3
*3 Asahi Carbon's product name “#80”
*4 Tosoh Silica's product name “Nipsil AQ”, having BET surface area of 220 m²/g
*5 Bis(3-triethoxysilylpropyl) disulfide(mean sulfur chain length: 2.35), Evonik's silane coupling agent, product name “Si75”
*6 Thioacetamide
*7 Thiobenzamide
*8 1-Methylpyrrolidine-2-thione
*9 1,3-Diphenylguanidine, by Sanshin Chemical Industry, product name “Sanceler D”
*10 2,2,4-Trimethyl-1,2-dihydroquinoline polymer, by Ouchi Shinko Chemical Industry, product name “Nocrac 224”
*11 N-(1,3-dimethylbutyl)-N′-phenyl-p-phenylenediamine, by Ouchi Shinko Chemical Industry, product name “Nocrac 6C”
*12 Di-2-benzothiazolyl Bisulfide, by Sanshin Chemical Industry, product name “Sanceler DM”
*13 N-tert-butyl-2-benzothiazolylsulfenamide, by Sanshin Chemical Industry, product name “Sanceler NS”

The rubber compositions of Examples 15 to 23 shown in Table 2 all have a good low-heat-generation property (tan δ index), as compared with the rubber compositions of Comparative Examples 9 to 10.

The rubber compositions of Examples 15 to 20 were obtained by changing the type and the amount of the thioamide compound (B-2) per 100 parts by mass of the synthetic dienic rubber. Of the three types of thioamide compounds (B-2), the case of using thiobenzamide provided the best low-heat-generation property and was excellent in the abrasion resistance index. Of the cases of using thioacetamide, those in which the amount of the compound is larger within a range of from 0.25 parts by mass to 2 parts by mass had a better low-heat-generation property.

The rubber compositions of Examples 21 to 23 were obtained by using a combination of synthetic dienic rubber and natural rubber in a ratio of 1/1 as the rubber component and by changing the type of the thioamide compound (B-2). Of those three types of thioamide compounds (B-2) in these Examples 21 to 23, in case where tiobenzamide is used, thioamide provided the best low-heat-generation property and was excellent in the abrasion resistance index.

On the other hand, in Comparative Example 9 and Comparative Example 10, the rubber compositions did not contain the thioamide compound (B-2) and are therefore known to be poor in the low-heat-generation property and the abrasion resistance index.

### Examples 24 to 31

In the first kneading stage in kneading, a rubber component (A), maleic acid of an acidic compound (B-3), carbon black, an inorganic filler (C), a silane coupling agent (D), aromatic oil, stearic acid and an antiaging agent 6PPD were kneaded in a Banbury mixer, and the maximum temperature of the rubber composition in the first kneading stage was controlled to be 150° C.

Next, in the final stage of kneading, the remaining components shown in Table 3 and Table 4 were added and kneaded, and the maximum temperature of the rubber composition in the final kneading stage was controlled to be 110° C.

The low-heat-generation property (tan δ index) and the abrasion resistance of the vulcanized rubber composition obtained from the above rubber composition were evaluated according to the above-mentioned methods. The results are shown in Table 3 and Table 4.

### Comparative Example 11

The components were kneaded in the same manner as in Examples 24 to 27 except that maleic acid was not added in the first kneading stage. The low-heat-generation property (tan δ index) of the thus-obtained, vulcanized rubber composition was evaluated according to the above-mentioned method. The results are shown in Table 3.

### Comparative Examples 12 to 15

The components were kneaded in the same manner as in Comparative Example 11 except that maleic acid was added in the final kneading stage. The low-heat-generation property (tan δ index) of the thus-obtained, vulcanized rubber composition was evaluated according to the above-mentioned method. The results are shown in Table 3.

### Comparative Example 16

The components were kneaded in the same manner as in Examples 28 to 31 except that maleic acid was not added in the first kneading stage. The low-heat-generation property (tan δ index) of the thus-obtained, vulcanized rubber composition was evaluated according to the above-mentioned method. The results are shown in Table 4.

### Comparative Examples 17 to 20

The components were kneaded in the same manner as in Comparative Example 16 except that maleic acid was added in the final kneading stage. The low-heat-generation property (tan δ index) of the thus-obtained, vulcanized rubber composition was evaluated according to the above-mentioned method. The results are shown in Table 4.

### [Table 3]

TABLE 3

| | | | Example | | | | Comparative Example | | | | |
|---|---|---|---|---|---|---|---|---|---|---|---|
| | | part by mass | 24 | 25 | 26 | 27 | 11 | 12 | 13 | 14 | 15 |
| Components | First | SBR *1 | 100 | 100 | 100 | 100 | 100 | 100 | 100 | 100 | 100 |
| of Rubber | Kneading | Natural Rubber *2 | — | — | — | — | — | — | — | — | — |
| Composition | Stage | Carbon Black N220 *3 | 10 | 10 | 10 | 10 | 10 | 10 | 10 | 10 | 10 |
| | | Silica *4 | 50 | 50 | 50 | 50 | 50 | 50 | 50 | 50 | 50 |
| | | Maleic Acid *5 | 0.5 | 1 | 2 | 3 | — | — | — | — | — |
| | | Silane Coupling Agent | 5 | 5 | 5 | 5 | 5 | 5 | 5 | 5 | 5 |
| | | Si75 *6 | | | | | | | | | |
| | | Aromatic Oil | 30 | 30 | 30 | 30 | 30 | 30 | 30 | 30 | 30 |
| | | Stearic Acid | 2 | 2 | 2 | 2 | 2 | 2 | 2 | 2 | 2 |
| | | Antiaging Agent | 1 | 1 | 1 | 1 | 1 | 1 | 1 | 1 | 1 |
| | | 6PPD *7 | | | | | | | | | |
| | Final | Maleic Acid *5 | — | — | — | — | — | 0.5 | 1 | 2 | 3 |
| | Kneading | Zinc oxide | 2.5 | 2.5 | 2.5 | 2.5 | 2.5 | 2.5 | 2.5 | 2.5 | 2.5 |
| | Stage | Antiaging Agent | 1 | 1 | 1 | 1 | 1 | 1 | 1 | 1 | 1 |
| | | TMDQ *8 | | | | | | | | | |
| | | Vulcanization Promoter | 0.6 | 0.6 | 0.6 | 0.6 | 0.6 | 0.6 | 0.6 | 0.6 | 0.6 |
| | | DPG *9 | | | | | | | | | |
| | | Vulcanization Promoter | 1 | 1 | 1 | 1 | 1 | 1 | 1 | 1 | 1 |
| | | MBTS *10 | | | | | | | | | |
| | | Vulcanization Promoter | 0.6 | 0.6 | 0.6 | 0.6 | 0.6 | 0.6 | 0.6 | 0.6 | 0.6 |
| | | TBBS *11 | | | | | | | | | |
| | | Sulfur | 1.5 | 1.5 | 1.5 | 1.5 | 1.5 | 1.5 | 1.5 | 1.5 | 1.5 |

| | | | | | | | | | | |
|---|---|---|---|---|---|---|---|---|---|---|
| Properties of | Low-Heat-Generation | 120 | 122 | 123 | 124 | 100 | 100 | 101 | 101 | 101 |
| Vulcanized Rubber | Properly | | | | | | | | | |
| | (tanδ index) | | | | | | | | | |

TABLE 4

| | | | Example | | | | Comparative Example | | | | |
|---|---|---|---|---|---|---|---|---|---|---|---|
| | | part by mass | 28 | 29 | 30 | 31 | 16 | 17 | 18 | 19 | 20 |
| Components | First | SBR *1 | 50 | 50 | 50 | 50 | 50 | 50 | 50 | 50 | 50 |
| of Rubber | Kneading | Natural Rubber *2 | 50 | 50 | 50 | 50 | 50 | 50 | 50 | 50 | 50 |
| Composition | Stage | Carbon Black N220 *3 | 10 | 10 | 10 | 10 | 10 | 10 | 10 | 10 | 10 |
| | | Silica *4 | 50 | 50 | 50 | 50 | 50 | 50 | 50 | 50 | 50 |
| | | Maleic Acid *5 | 0.5 | 1 | 2 | 3 | — | — | — | — | — |
| | | Silane Coupling Agent | 5 | 5 | 5 | 5 | 5 | 5 | 5 | 5 | 5 |
| | | Si75 *6 | | | | | | | | | |
| | | Aromatic Oil | 30 | 30 | 30 | 30 | 30 | 30 | 30 | 30 | 30 |
| | | Stearic Acid | 2 | 2 | 2 | 2 | 2 | 2 | 2 | 2 | 2 |
| | | Antiaging Agent | 1 | 1 | 1 | 1 | 1 | 1 | 1 | 1 | 1 |
| | | 6PPD *7 | | | | | | | | | |
| | Final | Maleic Acid *5 | — | — | — | — | — | 0.5 | 1 | 2 | 3 |
| | Kneading | Zinc oxide | 2.5 | 2.5 | 2.5 | 2.5 | 2.5 | 2.5 | 2.5 | 2.5 | 2.5 |
| | Stage | Antiaging Agent | 1 | 1 | 1 | 1 | 1 | 1 | 1 | 1 | 1 |
| | | TMDQ *8 | | | | | | | | | |
| | | Vulcanization Promoter | 0.6 | 0.6 | 0.6 | 0.6 | 0.6 | 0.6 | 0.6 | 0.6 | 0.6 |
| | | DPG *9 | | | | | | | | | |
| | | Vulcanization Promoter | 1 | 1 | 1 | 1 | 1 | 1 | 1 | 1 | 1 |
| | | MBTS *10 | | | | | | | | | |
| | | Vulcanization Promoter | 0.6 | 0.6 | 0.6 | 0.6 | 0.6 | 0.6 | 0.6 | 0.6 | 0.6 |
| | | TBBS *11 | | | | | | | | | |
| | | Sulfur | 1.5 | 1.5 | 1.5 | 1.5 | 1.5 | 1.5 | 1.5 | 1.5 | 1.5 |

| | | | | | | | | | | |
|---|---|---|---|---|---|---|---|---|---|---|
| Properties of | Low-Heat-Generation | 113 | 117 | 119 | 120 | 100 | 100 | 100 | 101 | 101 |
| Vulcanized Rubber | Properly | | | | | | | | | |
| | (tanδ index) | | | | | | | | | |

[Notes]
The following *1 to *11 are for Table 3 and Table 4.
*1 Asahi Kasei's solution-polymerized SBR, product name “Toughden 2000”
*2 RSS#3
*3 N220 (ISAF), by Asahi Carbon, product name “#80”
*4 Tosoh Silica's product name “Nipsil AQ“, having BET surface area of 205 m²/g
*5 Maleic acid, by Wako Pure Chemicals
*6 Bis(3-triethoxysilylpropyl) disulfide (mean sulfur chain length: 2.35), Evonik's silane coupling agent, product name “Si75” ®
*7 N-(1,3-dimethylbutyl)-N′-phenyl-p-phenylenediamine, by Ouchi Shinko Chemical Industry, product name “Nocrac 6C”
*8 2,2,4-Trimethyl-1,2-dihydroquinoline polymer, by Ouchi Shinko Chemical Industry, product name “Nocrac 224”
*9 1,3-Diphenylguanidine, by Sanshin Chemical Industry, product name “Sanceler D”
*10 Di-2-benzothiazolyl Disulfide, by Sanshin Chemical Industry, product name “Sanceler DM”
*11 N-tert-butyl-2-benzothiazolylsulfenamide, by Sanshin Chemical Industry, product name “Sanceler NS”

As obvious from Table 3, the rubber compositions of Examples 24 to 27 all have a good low-heat-generation property (tan δ index), as compared with the comparative rubber compositions of Comparative Examples 11 to 15.

Also as obvious from Table 4, the rubber compositions of Examples 28 to 31 all have a good low-heat-generation property (tan δ index), as compared with the comparative rubber compositions of Comparative Examples 16 to 20.

### Examples 32 to 35

In the first kneading stage in kneading, a rubber component (A), L-cysteine as a nucleophilic reagent (B-4), 1,3-diphenylguanidine as a guanidine compound (B-5), carbon black, silica as an inorganic filler (C), Si75 as a silane coupling agent (D), aromatic oil, and an antiaging agent 6PPD were kneaded in a Banbury mixer according to Table 5, and the maximum temperature of the rubber composition in the first kneading stage was controlled to be 150° C.

Next, in the final stage of kneading, the remaining components and the remaining 1,3-diphenylguanidine shown in Table 5 were added and kneaded, and the maximum temperature of the rubber composition in the final kneading stage was controlled to be 110° C.

The low-heat-generation property (tan δ index) of the vulcanized rubber composition obtained from the above rubber composition was evaluated according to the above-mentioned method. The results are shown in Table 5.

### Comparative Example 21

The components were kneaded in the same manner as in Examples 32 to 35 except that L-cysteine and 1,3-diphenylguanidine were not added in the first kneading stage. The low-heat-generation property (tan δ index) of the thus-obtained, vulcanized rubber composition was evaluated according to the above-mentioned method. The results are shown in Table 5.

### Comparative Example 22

The components were kneaded in the same manner as in Comparative Example 21 except that L-cysteine was added in the final kneading stage according to Table 5. The low-heat-generation property (tan δ index) of the thus-obtained, vulcanized rubber composition was evaluated according to the above-mentioned method. The results are shown in Table 5.

### Comparative Example 23

The components were kneaded in the same manner as in Comparative Example 21 except that 1,3-diphenylguanidine was added in the final kneading stage according to Table 5. The low-heat-generation property (tan δ index) of the thus-obtained, vulcanized rubber composition was evaluated according to the above-mentioned method. The results are shown in Table 5.

### Comparative Example 24

The components were kneaded in the same manner as in Comparative Example 21 except that L-cysteine was added in the first kneading stage according to Table 5. The low-heat-generation property (tan δ index) of the thus-obtained, vulcanized rubber composition was evaluated according to the above-mentioned method. The results are shown in Table 5.

### Comparative Example 25

The components were kneaded in the same manner as in Comparative Example 21 except that 1,3-diphenylguanidine was added in the first kneading stage according to Table 5. The low-heat-generation property (tan δ index) of the thus-obtained, vulcanized rubber composition was evaluated according to the above-mentioned method. The results are shown in Table 5.

### Comparative Examples 26 and 27

The components were kneaded in the same manner as in Comparative Example 21 except that L-cysteine and 1,3-diphenylguanidine were added in the final kneading stage according to Table 5. The low-heat-generation property (tan δ index) of the thus-obtained, vulcanized rubber composition was evaluated according to the above-mentioned method. The results are shown in Table 5.

TABLE 5

| | | | Example | | | | Comparative Example | | | | | | |
|---|---|---|---|---|---|---|---|---|---|---|---|---|---|
| part by mass | | | 32 | 33 | 34 | 35 | 21 | 22 | 23 | 24 | 25 | 26 | 27 |
| Components | First | Emulsion-polymerized | 100 | 100 | 100 | 100 | 100 | 100 | 100 | 100 | 100 | 100 | 100 |
| of Rubber | Kneading | SBR *1 | | | | | | | | | | | |
| Composition | Step | Natural Rubber *2 | — | — | — | — | — | — | — | — | — | — | — |
| | | Carbon Black N220 *3 | 10 | 10 | 10 | 10 | 10 | 10 | 10 | 10 | 10 | 10 | 10 |
| | | Silica *4 | 50 | 50 | 50 | 50 | 50 | 50 | 50 | 50 | 50 | 50 | 50 |
| | | L-cysteine | 0.5 | 1 | 0.5 | 1 | — | — | — | 1 | — | — | — |
| | | 1,3-diphenylguanidine *5 | 0.5 | 1 | 0.5 | 1 | — | — | — | — | 1 | — | — |
| | | Silane Coupling Agent | 5 | 5 | 5 | 5 | 5 | 5 | 5 | 5 | 5 | 5 | 5 |
| | | Si75 *6 | | | | | | | | | | | |
| | | Aromatic Oil | 30 | 30 | 30 | 30 | 30 | 30 | 30 | 30 | 30 | 30 | 30 |
| | | Stearic Acid | 2 | 2 | — | — | 2 | 2 | 2 | 2 | 2 | 2 | 2 |
| | | Antiaging Agent | 1 | 1 | 1 | 1 | 1 | 1 | 1 | 1 | 1 | 1 | 1 |
| | | 6PPD *7 | | | | | | | | | | | |
| | Final | L-cysteine | — | — | — | — | — | 1 | — | — | — | 0.5 | 1 |
| | Kneading | Stearic Acid | — | — | 2 | 2 | — | — | — | — | — | — | — |
| | Step | Antiaging Agent | 1 | 1 | 1 | 1 | 1 | 1 | 1 | 1 | 1 | 1 | 1 |
| | | TMDQ *8 | | | | | | | | | | | |
| | | Zinc oxide | 2.5 | 2.5 | 2.5 | 2.5 | 2.5 | 2.5 | 2.5 | 2.5 | 2.5 | 2.5 | 2.5 |
| | | 1,3-Diphenylguanidine *5 | 0.6 | 0.6 | 0.6 | 0.6 | 0.6 | 0.6 | 1.6 | 0.6 | 0.6 | 1.1 | 1.6 |
| | | Vulcanization Promoter | 1 | 1 | 1 | 1 | 1 | 1 | 1 | 1 | 1 | 1 | 1 |
| | | MBTS *9 | | | | | | | | | | | |
| | | Vulcanization Promoter | 0.6 | 0.6 | 0.6 | 0.6 | 0.6 | 0.6 | 0.6 | 0.6 | 0.6 | 0.6 | 0.6 |
| | | TBBS *10 | | | | | | | | | | | |
| | | Sulfur | 1.5 | 1.5 | 1.5 | 1.5 | 1.5 | 1.5 | 1.5 | 1.5 | 1.5 | 1.5 | 1.5 |

| | | | | | | | | | | | | |
|---|---|---|---|---|---|---|---|---|---|---|---|---|
| Properties of | Low-Heat-Generation | 118 | 120 | 120 | 122 | 100 | 100 | 101 | 100 | 101 | 100 | 101 |
| Vulcanized Rubber | Property | | | | | | | | | | | |
| | (tanδ index) | | | | | | | | | | | |

[Notes]
The following *1 to *10 are for Table 5 and Table 6.
*1 JSR's solution-polymerized SBR, product name “#1500”
*2 RSS#3
*3 N220 (ISAF), by Asahi Carbon, product name “#80”
*4 Tosoh Silica's product name “Nipsil AQ”, having BET surface area of 205 m²/g
*5 1,3-Diphenylguanidine, by Sanshin Chemical Industry, product name “Sanceler D”
*6 Bis(3-triethoxysilylpropyl) disulfide (mean sulfur chain length: 2.35), Evonik's silane coupling agent, product name “Si75” ®
*7 N-(1,3-dimethylbutyl)-N′-phenyl-p-phenylenediamine, by Ouchi Shinko Chemical Industry, product name “Nocrac 6C”
*8 2,2,4-Trimethyl-1,2-dihydroquinoline polymer, by Ouchi Shinko Chemical Industry, product name “Nocrac 224”
*9 Di-2-benzothiazolyl Disulfide, by Sanshin Chemical Industry, product name “Sanceler DM”
*10 N-tert-butyl-2-benzothiazolylsulfenamide, by Sanshin Chemical Industry, product name “Sanceler NS”

### Examples 36 to 39

In the first kneading stage in kneading, a rubber component (A), L-cysteine as a nucleophilic reagent (B-4), 1,3-diphenylguanidine as a guanidine compound (B-5), carbon black, silica as an inorganic filler (C), Si75 as a silane coupling agent (D), aromatic oil, and an antiaging agent 6PPD were kneaded in a Banbury mixer according to Table 6, and the maximum temperature of the rubber composition in the first kneading stage was controlled to be 150° C.

Next, in the final stage of kneading, the remaining components and the remaining 1,3-diphenylguanidine shown in Table 6 were added and kneaded, and the maximum temperature of the rubber composition in the final kneading stage was controlled to be 110° C.

The low-heat-generation property (tan δ index) of the vulcanized rubber composition obtained from the above rubber composition was evaluated according to the above-mentioned method. The results are shown in Table 6.

### Comparative Examples 28 to 34

The components were kneaded in the same manner as in Comparative Examples 21 to 27 according to Table 6, in which, however, the rubber component (A) differed. The low-heat-generation property (tan δ index) of the thus-obtained, vulcanized rubber composition was evaluated according to the above-mentioned method. The results are shown in Table 6.

TABLE 6

| | | | Example | | | | Comparative Example | | | | | | |
|---|---|---|---|---|---|---|---|---|---|---|---|---|---|
| part by mass | | | 36 | 37 | 38 | 39 | 28 | 29 | 30 | 31 | 32 | 33 | 34 |
| Components | First | Emulsion-polymerized | 50 | 50 | 50 | 50 | 50 | 50 | 50 | 50 | 50 | 50 | 50 |
| of Rubber | Kneading | SBR *1 | | | | | | | | | | | |
| Composition | Stage | Natural Rubber *2 | 50 | 50 | 50 | 50 | 50 | 50 | 50 | 50 | 50 | 50 | 50 |
| | | Carbon Black N220 *3 | 10 | 10 | 10 | 10 | 10 | 10 | 10 | 10 | 10 | 10 | 10 |
| | | Silica *4 | 50 | 50 | 50 | 50 | 50 | 50 | 50 | 50 | 50 | 50 | 50 |
| | | L-cysteine | 0.5 | 1 | 0.5 | 1 | — | — | — | 1 | — | — | — |
| | | 1,3-Diphenylguanidine *5 | 0.5 | 1 | 0.5 | 1 | — | — | — | — | 1 | — | — |
| | | Silane Coupling Agent | 5 | 5 | 5 | 5 | 5 | 5 | 5 | 5 | 5 | 5 | 5 |
| | | Si75 *6 | | | | | | | | | | | |
| | | Aromatic Oil | 30 | 30 | 30 | 30 | 30 | 30 | 30 | 30 | 30 | 30 | 30 |
| | | Stearic Acid | 2 | 2 | — | — | 2 | 2 | 2 | 2 | 2 | 2 | 2 |
| | | Antiaging Agent | 1 | 1 | 1 | 1 | 1 | 1 | 1 | 1 | 1 | 1 | 1 |
| | | 6PPD *7 | | | | | | | | | | | |
| | Final | L-cysteine | — | — | — | — | — | 1 | — | — | — | 0.5 | 1 |
| | Kneading | Stearic Acid | — | — | 2 | 2 | — | — | — | — | — | — | — |
| | Stage | Antiaging Agent | 1 | 1 | 1 | 1 | 1 | 1 | 1 | 1 | 1 | 1 | 1 |
| | | TMDQ *8 | | | | | | | | | | | |
| | | Zinc oxide | 2.5 | 2.5 | 2.5 | 2.5 | 2.5 | 2.5 | 2.5 | 2.5 | 2.5 | 2.5 | 2.5 |
| | | 1,3-Diphenylguanidine *5 | 0.6 | 0.6 | 0.6 | 0.6 | 0.6 | 0.6 | 1.6 | 0.6 | 0.6 | 1.1 | 1.6 |
| | | Vulcanization Promoter | 1 | 1 | 1 | 1 | 1 | 1 | 1 | 1 | 1 | 1 | 1 |
| | | MBTS *9 | | | | | | | | | | | |
| | | Diphenylguanidine | 0.6 | 0.6 | 0.6 | 0.6 | 0.6 | 0.6 | 0.6 | 0.6 | 0.6 | 0.6 | 0.6 |
| | | TBBS *10 | | | | | | | | | | | |
| | | Sulfur | 1.5 | 1.5 | 1.5 | 1.5 | 1.5 | 1.5 | 1.5 | 1.5 | 1.5 | 1.5 | 1.5 |

| | | | | | | | | | | | | |
|---|---|---|---|---|---|---|---|---|---|---|---|---|
| Properties of | Low-Heat-Generation | 114 | 116 | 116 | 118 | 100 | 101 | 101 | 100 | 101 | 100 | 101 |
| Vulcanized Rubber | Properly | | | | | | | | | | | |
| | (tanδ index) | | | | | | | | | | | |

[Notes]
*1 to *10 are the same as in Table 5.

As obvious from Table 5 and Table 6, the rubber compositions of Examples 32 to 39 all have a good low-heat-generation property (tan δ index), as compared with the comparative rubber compositions of Comparative Examples 21 to 34.

### Examples 40 to 53

In the first kneading stage in kneading, a rubber component (A), a phosphorous acid compound (B-6), carbon black, an inorganic filler (C), a silane coupling agent (D), aromatic oil, stearic acid and an antiaging agent 6PPD were kneaded in a Banbury mixer, and the maximum temperature of the rubber composition in the first kneading stage was controlled to be 150° C. Next, in the final stage of kneading, the remaining components shown in Table 7 were added and kneaded, and the maximum temperature of the rubber composition in the final kneading stage was controlled to be 110° C.

The low-heat-generation property (tan δ index) and the abrasion resistance of the vulcanized rubber composition obtained from the above rubber composition were evaluated according to the above-mentioned methods. The results are shown in Table 7.

### Example 54

The components were kneaded in the same manner as in Examples 40 to 53 except that the phosphorous acid compound (B-6) was not added in the first kneading stage but was added in the final kneading stage. The low-heat-generation property (tan δ index) and the abrasion resistance of the thus-obtained, vulcanized rubber composition were evaluated according to the above-mentioned methods. The results are shown in Table 7.

### Example 55

In the first kneading stage in kneading, a rubber component (A), carbon black, all of an inorganic filler (C), a silane coupling agent (D), aromatic oil, stearic acid and an antiaging agent 6PPD were kneaded for 60 seconds, and then a phosphorous acid compound (B-6) was added thereto and further kneaded. The maximum temperature of the rubber composition in the first kneading stage was controlled to be 150° C. Next, in the final stage of kneading, the remaining components shown in Table 7 were added and kneaded, and the maximum temperature of the rubber composition in the final kneading stage was controlled to be 110° C.

The low-heat-generation property (tan δ index) and the abrasion resistance of the vulcanized rubber composition obtained from the above rubber composition were evaluated according to the above-mentioned methods. The results are shown in Table 7.

### Comparative Examples 35 to 42

The components were kneaded in the same manner as in Examples 40 to 53 except that the phosphorous acid compound (B-6) was not added in the first kneading stage. The low-heat-generation property (tan δ index) and the abrasion resistance of the thus-obtained, vulcanized rubber composition were evaluated according to the above-mentioned methods. The results are shown in Table 7.

TABLE 7

| Components | | | Example | | | | | | | | | | | | |
|---|---|---|---|---|---|---|---|---|---|---|---|---|---|---|---|
| (part by mass) | | | 40 | 41 | 42 | 43 | 44 | 45 | 46 | 47 | 48 | 49 | 50 | 51 | 52 |
| Components | First | SBR*1 | 100 | 100 | 100 | 100 | 100 | 100 | 100 | 50 | 50 | 50 | 50 | 100 | 100 |
| of Rubber | Kneading | Natural Rubber *2 | 0 | 0 | 0 | 0 | 0 | 0 | 0 | 50 | 50 | 50 | 50 | 0 | 0 |
| Composition | Stage | Carbon Black-1 N220 *3 | 10 | 10 | 10 | 10 | 10 | 10 | 10 | 10 | 10 | 10 | 10 | 10 | 10 |
| | | Silica *4 | 50 | 50 | 50 | 50 | 50 | 50 | 50 | 50 | 50 | 50 | 50 | 50 | 50 |
| | | Silane Coupling Agent *5 | 5 | 5 | 5 | 5 | 5 | 5 | 5 | 5 | 5 | 5 | 5 | 0 | 0 |
| | | Silane Coupling Agent *6 | 0 | 0 | 0 | 0 | 0 | 0 | 0 | 0 | 0 | 0 | 0 | 5 | 0 |
| | | Silane Coupling Agent *7 | 0 | 0 | 0 | 0 | 0 | 0 | 0 | 0 | 0 | 0 | 0 | 0 | 5 |
| | | Silane Coupling Agent *8 | 0 | 0 | 0 | 0 | 0 | 0 | 0 | 0 | 0 | 0 | 0 | 0 | 0 |
| | | Phosphorous Acid | 0.25 | 0.5 | 1 | 2 | 0 | 0 | 0 | 1 | 0 | 0 | 0 | 1 | 1 |
| | | Compound | | | | | | | | | | | | | |
| | | (B)-(a) *9 | | | | | | | | | | | | | |
| | | Phosphorous Acid | 0 | 0 | 0 | 0 | 1 | 0 | 0 | 0 | 1 | 0 | 0 | 0 | 0 |
| | | Compound | | | | | | | | | | | | | |
| | | (B)-(b) *10 | | | | | | | | | | | | | |
| | | Phosphorous Acid | 0 | 0 | 0 | 0 | 0 | 1 | 0 | 0 | 0 | 1 | 0 | 0 | 0 |
| | | Compound | | | | | | | | | | | | | |
| | | (B)-(b) *11 | | | | | | | | | | | | | |
| | | Phosphorous Acid | 0 | 0 | 0 | 0 | 0 | 0 | 1 | 0 | 0 | 0 | 1 | 0 | 0 |
| | | Compound | | | | | | | | | | | | | |
| | | (B)-(c) *12 | | | | | | | | | | | | | |
| | | Aromatic Oil | 30 | 30 | 30 | 30 | 30 | 30 | 30 | 30 | 30 | 30 | 30 | 30 | 30 |
| | Final | Stearic Acid | 2 | 2 | 2 | 2 | 2 | 2 | 2 | 2 | 2 | 2 | 2 | 2 | 2 |
| | Kneading | Phosphorous Acid | 0 | 0 | 0 | 0 | 0 | 0 | 0 | 0 | 0 | 0 | 0 | 0 | 0 |
| | Stage | Compound | | | | | | | | | | | | | |
| | | (B)-(a) *9 | | | | | | | | | | | | | |
| | | Phosphorous Acid | 0 | 0 | 0 | 0 | 0 | 0 | 0 | 0 | 0 | 0 | 0 | 0 | 0 |
| | | Compound | | | | | | | | | | | | | |
| | | (B)-(b) *10 | | | | | | | | | | | | | |
| | | Phosphorous Acid | 0 | 0 | 0 | 0 | 0 | 0 | 0 | 0 | 0 | 0 | 0 | 0 | 0 |
| | | Compound | | | | | | | | | | | | | |
| | | (B)-(b) *11 | | | | | | | | | | | | | |
| | | Phosphorous Acid | 0 | 0 | 0 | 0 | 0 | 0 | 0 | 0 | 0 | 0 | 0 | 0 | 0 |
| | | Compound | | | | | | | | | | | | | |
| | | (B)-(c) *12 | | | | | | | | | | | | | |
| | | Antiaging Agent | 1 | 1 | 1 | 1 | 1 | 1 | 1 | 1 | 1 | 1 | 1 | 1 | 1 |
| | | 6PPD *13 | | | | | | | | | | | | | |
| | | Vulcanization Promoter | 0.6 | 0.6 | 0.6 | 0.6 | 0.6 | 0.6 | 0.6 | 0.6 | 0.6 | 0.6 | 0.6 | 0.6 | 0.6 |
| | | DPG *14 | | | | | | | | | | | | | |
| | | Antiaging Agent | 1 | 1 | 1 | 1 | 1 | 1 | 1 | 1 | 1 | 1 | 1 | 1 | 1 |
| | | TMDQ *15 | | | | | | | | | | | | | |
| | | Zinc oxide | 2.5 | 2.5 | 2.5 | 2.5 | 2.5 | 2.5 | 2.5 | 2.5 | 2.5 | 2.5 | 2.5 | 2.5 | 2.5 |
| | | Vulcanization Promoter | 1 | 1 | 1 | 1 | 1 | 1 | 1 | 1 | 1 | 1 | 1 | 1 | 1 |
| | | MBTS *16 | | | | | | | | | | | | | |
| | | Vulcanization Promoter | 0.6 | 0.6 | 0.6 | 0.6 | 0.6 | 0.6 | 0.6 | 0.6 | 0.6 | 0.6 | 0.6 | 0.6 | 0.6 |
| | | TBBS *17 | | | | | | | | | | | | | |
| | | Sulfur | 1.5 | 1.5 | 1.5 | 1.5 | 1.5 | 1.5 | 1.5 | 1.5 | 1.5 | 1.5 | 1.5 | 1.5 | 1.5 |

| | | | | | | | | | | | | | | |
|---|---|---|---|---|---|---|---|---|---|---|---|---|---|---|
| Properties of | Low-Heat-Generation | 121 | 123 | 127 | 128 | 118 | 117 | 117 | 122 | 115 | 114 | 114 | 116 | 115 |
| Vulcanized Rubber | Property | | | | | | | | | | | | | |
| | (tanδ index) | | | | | | | | | | | | | |
| | Abrasion Resistance | 104 | 105 | 106 | 107 | 102 | 103 | 103 | 105 | 103 | 104 | 104 | 95 | 105 |
| | Index | | | | | | | | | | | | | |

| Components | | | Example | | | Comparative Example | | | | | | | |
|---|---|---|---|---|---|---|---|---|---|---|---|---|---|
| (part by mass) | | | 53 | 54 | 55 | 35 | 36 | 37 | 38 | 39 | 40 | 41 | 42 |
| Components | First | SBR*1 | 100 | 100 | 100 | 100 | 50 | 100 | 50 | 100 | 50 | 100 | 50 |
| of Rubber | Kneading | Natural Rubber *2 | 0 | 0 | 0 | 0 | 50 | 0 | 50 | 0 | 50 | 0 | 50 |
| Composition | Stage | Carbon Black-1 N220 *3 | 10 | 10 | 10 | 10 | 10 | 10 | 10 | 10 | 10 | 10 | 10 |
| | | Silica *4 | 50 | 50 | 50 | 50 | 50 | 50 | 50 | 50 | 50 | 50 | 50 |
| | | Silane Coupling Agent *5 | 0 | 5 | 5 | 5 | 5 | 0 | 0 | 0 | 0 | 0 | 0 |
| | | Silane Coupling Agent *6 | 0 | 0 | 0 | 0 | 0 | 5 | 5 | 0 | 0 | 0 | 0 |
| | | Silane Coupling Agent *7 | 0 | 0 | 0 | 0 | 0 | 0 | 0 | 5 | 5 | 0 | 0 |
| | | Silane Coupling Agent *8 | 5 | 0 | 0 | 0 | 0 | 0 | 0 | 0 | 0 | 5 | 5 |
| | | Phosphorous Acid | 1 | 0 | 1 | 0 | 0 | 0 | 0 | 0 | 0 | 0 | 0 |
| | | Compound | | | | | | | | | | | |
| | | (B)-(a) *9 | | | | | | | | | | | |
| | | Phosphorous Acid | 0 | 0 | 0 | 0 | 0 | 0 | 0 | 0 | 0 | 0 | 0 |
| | | Compound | | | | | | | | | | | |
| | | (B)-(b) *10 | | | | | | | | | | | |
| | | Phosphorous Acid | 0 | 0 | 0 | 0 | 0 | 0 | 0 | 0 | 0 | 0 | 0 |
| | | Compound | | | | | | | | | | | |
| | | (B)-(b) *11 | | | | | | | | | | | |
| | | Phosphorous Acid | 0 | 0 | 0 | 0 | 0 | 0 | 0 | 0 | 0 | 0 | 0 |
| | | Compound | | | | | | | | | | | |
| | | (B)-(c) *12 | | | | | | | | | | | |
| | | Aromatic Oil | 30 | 30 | 30 | 30 | 30 | 30 | 30 | 30 | 30 | 30 | 30 |
| | Final | Stearic Acid | 2 | 2 | 2 | 2 | 2 | 2 | 2 | 2 | 2 | 2 | 2 |
| | Kneading | Phosphorous Acid | 0 | 1 | 0 | 0 | 0 | 0 | 0 | 0 | 0 | 0 | 0 |
| | Stage | Compound | | | | | | | | | | | |
| | | (B)-(a) *9 | | | | | | | | | | | |
| | | Phosphorous Acid | 0 | 0 | 0 | 0 | 0 | 0 | 0 | 0 | 0 | 0 | 0 |
| | | Compound | | | | | | | | | | | |
| | | (B)-(b) *10 | | | | | | | | | | | |
| | | Phosphorous Acid | 0 | 0 | 0 | 0 | 0 | 0 | 0 | 0 | 0 | 0 | 0 |
| | | Compound | | | | | | | | | | | |
| | | (B)-(b) *11 | | | | | | | | | | | |
| | | Phosphorous Acid | 0 | 0 | 0 | 0 | 0 | 0 | 0 | 0 | 0 | 0 | 0 |
| | | Compound | | | | | | | | | | | |
| | | (B)-(c) *12 | | | | | | | | | | | |
| | | Antiaging Agent | 1 | 1 | 1 | 1 | 1 | 1 | 1 | 1 | 1 | 1 | 1 |
| | | 6PPD *13 | | | | | | | | | | | |
| | | Vulcanization Promoter | 0.6 | 0.6 | 0.6 | 0.6 | 0.6 | 0.6 | 0.6 | 0.6 | 0.6 | 0.6 | 0.6 |
| | | DPG *14 | | | | | | | | | | | |
| | | Antiaging Agent | 1 | 1 | 1 | 1 | 1 | 1 | 1 | 1 | 1 | 1 | 1 |
| | | TMDQ *15 | | | | | | | | | | | |
| | | Zinc oxide | 2.5 | 2.5 | 2.5 | 2.5 | 2.5 | 2.5 | 2.5 | 2.5 | 2.5 | 2.5 | 2.5 |
| | | Vulcanization Promoter | 1 | 1 | 1 | 1 | 1 | 1 | 1 | 1 | 1 | 1 | 1 |
| | | MBTS *16 | | | | | | | | | | | |
| | | Vulcanization Promoter | 0.6 | 0.6 | 0.6 | 0.6 | 0.6 | 0.6 | 0.6 | 0.6 | 0.6 | 0.6 | 0.6 |
| | | TBBS *17 | | | | | | | | | | | |
| | | Sulfur | 1.5 | 1.5 | 1.5 | 1.5 | 1.5 | 1.5 | 1.5 | 1.5 | 1.5 | 1.5 | 1.5 |

| | | | | | | | | | | | | |
|---|---|---|---|---|---|---|---|---|---|---|---|---|
| Properties of | Low-Heat-Generation | 126 | 109 | 129 | 100 | 101 | 105 | 106 | 106 | 107 | 104 | 105 |
| Vulcanized Rubber | Property | | | | | | | | | | | |
| | (tanδ index) | | | | | | | | | | | |
| | Abrasion Resistance | 107 | 102 | 107 | 100 | 101 | 92 | 93 | 100 | 101 | 98 | 99 |
| | Index | | | | | | | | | | | |

[Notes]
The following *1 to *17 are for Table 7.
*1 Asahi Kasei's solution-polymerized SBR, product name “T2000”
*2 RSS#3
*3 Asahi Carbon's product name “#80”
*4 Tosoh Silica's product name “Nipsil AQ”, having BET surface area of 205 m²/g
*5 Bis(3-triethoxysilylpropyl) disulfide(mean sulfur chain length: 2.35), Evonik's silane coupling agent, product name “Si75” ®
*6 3-Octanoylthiopropyltriethoxysilane, by Momentive Performance materials, product name “NXT Silane”
*7 Silane coupling agent represented by chemical formula (VII), by Momentive Performance Materials, product name “NXT-Z”
*8 Silane coupling agent obtained in Production Example 1, represented by the following mean compositional formula, (CH₃CH₂O)₃Si—(CH₂)₃—S—(CH₂)₆—S_{2.5}—(CH₂)₆—S—(CH₂)₃—Si(OCH₂CH₃)₃
*9 Tris(2-carboxyethyl) Phosphine Hydrochloride
*10 Triethyl Phosphite
*11 Tri-o-tolyl Phosphite
*12 Trihexyl Phosphine
*13 N-(1,3-dimethylbutyl)-N′-phenyl-p-phenylenediamine, by Ouchi Shinko Chemical Industry, product name “Nocrac 6C”
*14 1,3-Diphenylguanidine, by Sanshin Chemical Industry, product name “Sanceler D”
*15 2,2,4-Trimethyl-1,2-dihydroquinoline Polymer, by Ouchi Shinko Chemical Industry, product name “Nocrac 224”
*16 Di-2-benzothiazolyl Disulfide, by Sanshin Chemical Industry, product name “Sanceler DM”
*17 N-tert-butyl-2-benzothiazolylsulfenamide, by Sanshin Chemical Industry, product name “Sanceler NS”

As obvious from Table 7, the rubber compositions of Examples 40 to 55 all have a good low-heat-generation property (tan δ index), as compared with the rubber compositions of Comparative Examples 35 to 42.

The rubber compositions of Examples 40 to 46 were produced by changing the type of the phosphorous acid compound per 100 parts by mass of the synthetic dienic rubber therein. Of the phosphorous acid compounds, the cases of using tris(2-carboxy ester)phosphine hydrochloride provided the best low-heat-generation property. Of the cases of using tris(2-carboxyethyl)phosphine hydrochloride, those in which the amount of the compound is larger within a range of from 0.25 parts by mass to 2 parts by mass had a better low-heat-generation property.

The rubber compositions of Examples 47 to 50 each contains natural rubber and synthetic rubber in an amount of 50 part by mass each. Also of these cases, those using tris(2-carboxy ester)phosphine hydrochloride as the phosphorous acid compound had the best low-heat-generation property.

The rubber compositions of Examples 51 to 53 were produced by incorporating tris(2-carboxy ester)phosphine hydrochloride as the phosphorous acid compound and by changing the type of the silane coupling agent per 100 parts by mass of the synthetic dienic compound.

The combination of the silane coupling agent obtained in Production Example 1 and tris(2-carboxyethyl)phosphine hydrochloride provided the best low-heat-generation property.

The rubber composition of Example 54 was produced by adding the phosphorous acid compound (B-6) in the final kneading stage; and the rubber composition of Example 55 was comprised of the same constituent components as those in Example 54, but was produced by adding the phosphorous acid compound in the first kneading stage.

The rubber compositions of Examples 54 and 55 had a better low-heat-generation property as compared with the rubber composition of Comparative Example 35. However, when the two are compared with each other, one in which the phosphorous acid compound was added in the first kneading stage has a better low-heat-generation property.

### Examples 56 to 60 and Comparative Examples 43 to 44

According to the formulation and the kneading method shown in Table 8, rubber compositions of Examples 56 to 60 were produced by adding the rubber component and others, silica and the silane coupling agent, kneading the components for 0 second or 30 seconds, then further adding the hydrazide compound (B-7) shown in Table 8 and kneading them in the first kneading stage (in the first stage of kneading). When the rubber composition came to have a maximum temperature of 150° C., it was taken out of the kneader, thereby producing the rubber compositions of Examples 56 to 60. Here, the time of 0 second means that the hydrazide compound (B-7) and the silane coupling agent are added at the same time. A rubber composition of Comparative Composition 43 was produced according to the formulation shown in Table 8, by kneading the composition in the same manner as in Examples 56 to 59 except that the hydrazide compound (B-7) was not added thereto in the first kneading stage. In Comparative Example 44, the hydrazide compound (B-7) was not added in the first kneading stage but the hydrazide compound (B-7) was added in the final kneading stage (in the final stage of kneading). As the kneading machine, a Banbury mixer was used here.

The low-heat-generation property (tan δ index) and the abrasion resistance of the thus-obtained seven types of rubber compositions were evaluated according to the above-mentioned methods. The results are shown in Table 8.

TABLE 8

| Formulation | | Example | | | | | Comparative Example | |
|---|---|---|---|---|---|---|---|---|
| (part by mass) | | 56 | 57 | 58 | 59 | 60 | 43 | 44 |
| First | Solution-Polymerized SBR *1 | 100.00 | 100.00 | 100.00 | 100.00 | 100.00 | 100.00 | 100.00 |
| Kneading | N220 Carbon Black *2 | 10.00 | 10.00 | 10.00 | 10.00 | 10.00 | 10.00 | 10.00 |
| Stage | Silica *3 | 50.00 | 50.00 | 50.00 | 50.00 | 50.00 | 50.00 | 50.00 |
| | Silane Coupling Agent *4 | 5.00 | 5.00 | 5.00 | 5.00 | 5.00 | 5.00 | 5.00 |
| | Adipic Acid Dihydrazide *5 | 1.00 | — | — | — | 1.00 | — | — |
| | Isophthalic Acid Dihydrazide *6 | — | 1.00 | — | — | — | — | — |
| | Propionic Acid Hydrazide *7 | — | — | 1.00 | — | — | — | — |
| | 3-Hydroxy-2-naphthoic Acid | — | — | — | 1.00 | — | — | — |
| | Hydrazide *8 | | | | | | | |
| | Aromatic Oil | 30.00 | 30.00 | 30.00 | 30.00 | 30.00 | 30.00 | 30.00 |
| Final | Stearic Acid | 2.00 | 2.00 | 2.00 | 2.00 | 2.00 | 2.00 | 2.00 |
| Kneading | Antiaging Agent-6PPD *9 | 1.00 | 1.00 | 1.00 | 1.00 | 1.00 | 1.00 | 1.00 |
| Stage | Antiaging Agent-TMQ *10 | 1.00 | 1.00 | 1.00 | 1.00 | 1.00 | 1.00 | 1.00 |
| | Zinc oxide | 2.50 | 2.50 | 2.50 | 2.50 | 2.50 | 2.50 | 2.50 |
| | Adipic Acid Dihydrazide *5 | — | — | — | — | — | — | 1.00 |
| | Vulcanization Promoter-DPG *11 | 0.60 | 0.60 | 0.60 | 0.60 | 0.60 | 0.60 | 0.60 |
| | Vulcanization Promoter-MBTS *12 | 1.00 | 1.00 | 1.00 | 1.00 | 1.00 | 1.00 | 1.00 |
| | Vulcanization Promoter-TBBS *13 | 0.60 | 0.60 | 0.60 | 0.60 | 0.60 | 0.60 | 0.60 |
| | Sulfur | 1.50 | 1.50 | 1.50 | 1.50 | 1.50 | 1.50 | 1.50 |
| Time taken until addition of hydrazide compound | | 0 | 0 | 0 | 0 | 30 seconds | 0 | 0 |
| Properties of | tanδ (index) | 78 | 77 | 77 | 76 | 70 | 100 | 99 |
| Vulcanized Rubber | Abrasion Resistance | 101 | 101 | 100 | 102 | 102 | 100 | 101 |
| | (index) | | | | | | | |

[Notes]
The following *1 to *13 are for Table 8.
*1 Asahi Kasei's solution-polymerized SBR, product name “T2000”
*2 Asahi Carbon's product name “#80”
*3 Tosoh Silica's product name “Nipsil AQ”, having BET surface area of 205 m²/g
*4 Bis(3-triethoxysilylpropyl) disulfide(mean sulfur chain length: 2.35), Evonik's silane coupling agent, product name “Si75” ®
*5 Adipic acid dihydrazide, by Otsuka Chemical, molecular formula [C₆H₁₄N₄O₂], molecular weight: 174.2
*6 Isophthalic acid dihydrazide, by Otsuka Chemical, molecular formula [C₈H₁₀N₄O₂], molecular weight: 194.19
*7 Propionic acid hydrazide, by Otsuka Chemical, molecular formula [C₃H₈N₂O], molecular weight: 88.11
*8 3-Hydroxy-2-naphthoic acid hydrazide, by Otsuka Chemical, molecular formula [C₁₁H₁₀N₂O₂], molecular weight: 202.21
*9 N-(1,3-dimethylbutyl)-N′-phenyl-p-phenylenediamine, by Ouchi Shinko Chemical Industry, product name “Nocrac 6C”
*10 2,2,4-Trimethyl-1,2-dihydroquinoline Polymer, by Ouchi Shinko Chemical Industry, product name “Nocrac 224”
*11 1,3-Diphenylguanidine, by Sanshin Chemical Industry, product name “Sanceler D”
*12 Di-2-benzothiazolyl Disulfide, by Sanshin Chemical Industry, product name “Sanceler DM”
*13 N-tert-butyl-2-benzothiazolylsulfenamide, by Sanshin Chemical Industry, product name “Sanceler NS”

As obvious from Table 8, the rubber compositions of Examples 56 to 60 all have a good low-heat-generation property (tan δ index) as compared with the comparative rubber compositions of Comparative Examples 43 to 44.

### INDUSTRIAL APPLICABILITY

In the rubber composition of the present invention, the dispersibility of the filler is improved, and the composition has an excellent low-heat-generation property. In addition, in the composition, the activity of the coupling function of the silane coupling agent can be favorably prevented from being lowered, and the coupling function thereof is further enhanced, and therefore the composition has an especially excellent low-heat-generation property. Accordingly, the rubber composition is favorable for constitutive members of various types of pneumatic tires for passenger cars, small-sized trucks, minivans, pickup trucks and large-sized vehicles (trucks, buses, construction vehicles, etc.) and others, especially for tread members of pneumatic radial tires.

1. A rubber composition, which contains a rubber component (A), at least one organic sulfur compound (B) selected from a hydroxy group-having thiourea derivative (B-1) represented by the following general formula (I) and a thioamide compound (B-2) represented by the following general formula (II), and a filler containing an inorganic filler (C): 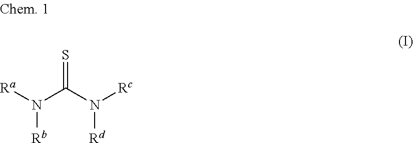
wherein R^{a}, R^{b}, R^{c} and R^{d} may be the same or different, each representing a functional group selected from an alkyl group, an alkyl group having a hydroxy group, an alkenyl group, an alkenyl group having a hydroxy group, an aryl group and an aryl group having a hydroxy group, or a hydrogen atom, and at least one of R^{a}, R^{b}, R^{c} and R^{d} is a functional group selected from an alkyl group having a hydroxy group, an alkenyl group having a hydroxy group and an aryl group having a hydroxy group, 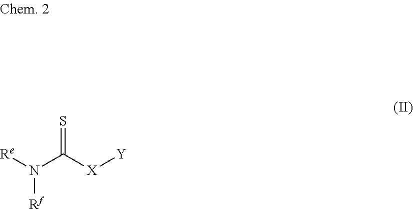
wherein R^{e} and R^{f} each independently represent any of a hydrogen atom, an aliphatic hydrocarbon group having from 1 to 10 carbon atoms, and an aromatic hydrocarbon group having from 6 to 20 carbon atoms; X represents any of a single bond, an aliphatic hydrocarbon group having from 1 to 10 carbon atoms, and an aromatic hydrocarbon group having from 6 to 20 carbon atoms; Y represents at least one selected from a hydrogen atom, an alkyl group having from 1 to 5 carbon atoms, a hydroxy group, an amino group and a halogen atom; and at least one of R^{e} and R^{f} may bond to X.

2. The rubber composition according to claim 1, wherein the organic sulfur compound (B) is a hydroxy group-having thiourea derivative (B-1) represented by the general formula (I).

3. The rubber composition according to claim 1, wherein the organic sulfur compound (B) is a thioamide compound (B-2) represented by the general formula (II), and the composition further contains a silane coupling agent (D).

4. The rubber composition according to claim 1, wherein in the hydroxy group-having thiourea derivative (B-1) represented by the general formula (I), R^{a} is a functional group selected from an allyl group, an alkyl group-substituted allyl group and an allyl group-having alkenyl group, R^{b} is a hydrogen atom, R^{c} is a functional group selected from a hydroxy group-having alkyl group, a hydroxy group-having alkenyl group and a hydroxy group-having aryl group, and R^{d} is a hydrogen atom.

5. The rubber composition according to claim 1, which further contains a silane coupling agent (D).

6. The rubber composition according to claim 5, wherein the amount of the hydroxy group-having thiourea derivative (B-1) is, as a ratio by mass of {hydroxy group-having thiourea derivative (B-1)/silane coupling agent (D)}, from (2/100) to (200/100).

7. The rubber composition according to claim 1, wherein the thioamide compound (B-2) is contained in an amount of from 0.1 to 5 parts by mass per 100 parts by mass of the rubber component (A).

8. The rubber composition according to claim 1, wherein the inorganic filler (C) is silica.

9. The rubber composition according to claim 1, wherein the inorganic filler (C) accounts for 30% by mass or more in the filler.

10. A method for producing a rubber composition that contains a rubber component (A), a hydroxy group-having thiourea derivative (B-1) represented by the following general formula (I), and a filler containing an inorganic filler (C);
the method including at least a first kneading stage of kneading the rubber component (A), the hydroxy group-having thiourea derivative (B-1), and all or a part of the inorganic filler (C), and,
after the first kneading stage, a final kneading stage of adding thereto a vulcanizing agent and further kneading them: 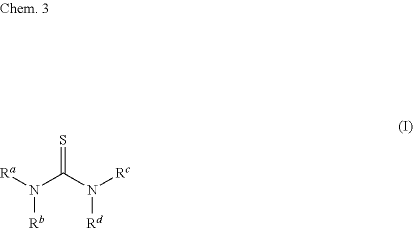
wherein R^{a}, R^{b}, R^{c} and R^{d} may be the same or different, each representing a functional group selected from an alkyl group, an alkyl group having a hydroxy group, an alkenyl group, an alkenyl group having a hydroxy group, an aryl group and an aryl group having a hydroxy group, or a hydrogen atom, and at least one of R^{a}, R^{b}, R^{c} and R^{d} is a functional group selected from an alkyl group having a hydroxy group, an alkenyl group having a hydroxy group and an aryl group having a hydroxy group.

11. The method for producing a rubber composition according to claim 10, wherein in the hydroxy group-having thiourea derivative (B-1) represented by the general formula (I), R^{a} is a functional group selected from an allyl group, an alkyl group-substituted allyl group and an allyl group-having alkenyl group, R^{b} is a hydrogen atom, R^{c} is a functional group selected from a hydroxy group-having alkyl group, a hydroxy group-having alkenyl group and a hydroxy group-having aryl group, and R^{d} is a hydrogen atom.

12. The method for producing a rubber composition according to claim 10, wherein a silane coupling agent (D) is added in the first kneading stage.

13. The method for producing a rubber composition according to claim 10, wherein in the first kneading stage, the rubber component (A) and all or a part of the inorganic filler (C) are kneaded, and then the hydroxy group-having thiourea derivative (B-1) is added thereto and further kneaded.

14. A method for producing a rubber composition that contains a rubber component (A), a thioamide compound (B-2) represented by the following general formula (II), a filler containing an inorganic filler (C), and a silane coupling agent (D); wherein the rubber composition is kneaded in plural stages, and in the first kneading stage, the rubber component (A), all or a part of the inorganic filler (C), all or a part of the silane coupling agent (D), and the thioamide compound (B-2) represented by the following general formula (II) are kneaded: 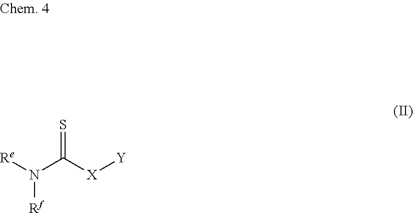
wherein R^{e} and R^{f} each independently represent any of a hydrogen atom, an aliphatic hydrocarbon group having from 1 to 10 carbon atoms, and an aromatic hydrocarbon group having from 6 to 20 carbon atoms; X represents any of a single bond, an aliphatic hydrocarbon group having from 1 to 10 carbon atoms, and an aromatic hydrocarbon group having from 6 to 20 carbon atoms; Y represents at least one selected from a hydrogen atom, an alkyl group having from 1 to 5 carbon atoms, a hydroxy group, an amino group and a halogen atom; and at least one of R^{e} and R^{f} may bond to X.

15. The method for producing a rubber composition according to claim 14, wherein in the first kneading stage, the rubber component (A), all or a part of the inorganic filler (C) and all or a part of the silane coupling agent (D) are kneaded, and then the thioamide compound (B-2) is added thereto and further kneaded.

16. A method for producing a rubber composition that contains a rubber component (A), an acidic compound (B-3) of which the logarithmic value pKa of the reciprocal number of the acid dissociation constant Ka is 4 or less, and a filler containing an inorganic filler (C);
the method including at least a first kneading stage of kneading the rubber component (A), the acidic compound (B-3), and all or a part of the inorganic filler (C), and,
after the first kneading stage, a final kneading stage of adding thereto a vulcanizing agent and further kneading them; wherein the method for measuring pKa comprises analyzing the compound in an aqueous solution at a temperature of 25° C. with a pH measuring apparatus, and the value in the dissociation stage 1 is pKa of the compound.

17. The method for producing a rubber composition according to claim 16, wherein the acidic compound (B-3) is at least one selected from maleic acid, cyclopropane-1,1-dicarboxylic acid, phthalic acid, fumaric acid, citric acid, oxalic acid, malonic acid, methylmalonic acid, (+)-tartaric acid, meso-tartaric acid, o-aminobenzoic acid, 4-aminosalicylic acid, 2-aminobutyric acid, o-chlorobenzoic acid, o-nitrobenzoic acid, nitroacetic acid, oxaloacetic acid, phenoxyacetic acid, bromoacetic acid, chloroacetic acid, cyanoacetic acid, dichloroacetic acid and 2-bromopropionic acid.

18. The method for producing a rubber composition according to claim 10, wherein the maximum temperature of the rubber composition in the first kneading stage is from 120 to 190° C.

19. The method for producing a rubber composition according to claim 16, wherein a silane coupling agent (D) is further added in the first kneading stage.

20. The method for producing a rubber composition according to claim 10, wherein the inorganic silica (C) is silica.

21. The method for producing a rubber composition according to claim 10, wherein the inorganic filler (C) accounts for 30% by mass or more in the filler.

22. The method for producing a rubber composition according to claim 16, wherein the amount of the acidic compound (B-3) is from 0.1 to 5 parts by mass per 100 parts by mass of the rubber component (A).

23. The method for producing a rubber composition according to claim 19, wherein the amount of the acidic compound (B-3) is, as a ratio by mass of {acidic compound (B-3)/silane coupling agent (D)}, from (2/100) to (200/100).

24. The method for producing a rubber composition according to claim 16, wherein in the first kneading stage, the rubber component (A) and all or a part of the inorganic filler (C) are kneaded and then the acidic compound (B-3) is added thereto and further kneaded.

25. A rubber composition that contains a rubber component (A), a nucleophilic reagent (B-4) except guanidine compounds, a guanidine compound (B-5), and a filler containing an inorganic filler (C).

26. The rubber composition according to claim 25, wherein the nucleophilic reagent (B-4) except guanidine compounds is at least one compound selected from cysteine and a cysteine derivative (b) represented by the following general formula (III): 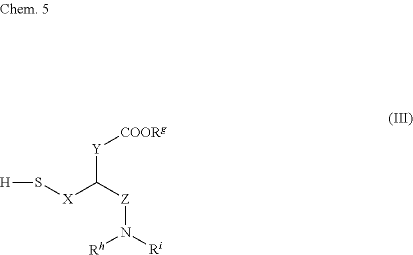
wherein X represents a divalent hydrocarbon group having a linear alkylene group and having from 1 to 10 carbon atoms; Y and Z each independently represent a single bond or an alkylene group having from 1 to 10 carbon atoms; R^{g} is selected from a hydrogen atom, an aliphatic hydrocarbon group, an alicyclic hydrocarbon group, an aromatic hydrocarbon group and an alkali metal; R^{h} and Rⁱ each are independently selected from a hydrogen atom, an aliphatic hydrocarbon group, an alicyclic hydrocarbon group, an aromatic hydrocarbon group and an acyl group; the —COO moiety may form a salt with an amine; the —NR^{h}Rⁱ moiety may form a salt with an acid; however, when all of R^{g}, R^{h} and Rⁱ are hydrogen atoms, the compound must form a salt, and in case where the compound does not form a salt, at least one of R^{g}, R^{h} and Rⁱ is not a hydrogen atom.

27. The rubber composition according to claim 25, which contains the guanidine compound (B-5) in an amount of from 0.1 to 3 parts by mass per 100 parts by mass of the rubber component (A).

28. The rubber composition according to claim 25, wherein the nucleophilic reagent (B-4) except guanidine compounds is cysteine.

29. The rubber composition according to claim 25, which further contains a silane coupling agent (D).

30. The rubber composition according to claim 25, wherein the inorganic filler (C) is silica.

31. The rubber composition according to claim 25, wherein the inorganic filler (C) accounts for 30% by mass or more in the filler.

32. The rubber composition according to claim 25, wherein the guanidine compound (B-5) is 1,3-diphenylguanidine.

33. A method for producing a rubber composition that contains a rubber component (A), a nucleophilic reagent (B-4) except guanidine compounds, a guanidine compound (B-5), and a filler containing an inorganic filler (C);
the method including a first kneading stage of kneading the rubber component (A), the nucleophilic reagent (B-4), the guanidine compound (B-5) and all or a part of the inorganic filler (C), and,
after the first kneading stage, a final kneading stage of adding thereto a vulcanizing agent and further kneading them.

34. The method for producing a rubber composition according to claim 33, wherein the nucleophilic reagent (B-4) except guanidine compounds is at least one compound selected from cysteine and a cysteine derivative (b) represented by the following general formula (III): 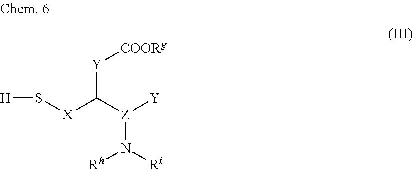
wherein X represents a divalent hydrocarbon group having a linear alkylene group and having from 1 to 10 carbon atoms; Y and Z each independently represent a single bond or an alkylene group having from 1 to 10 carbon atoms; R^{g} is selected from a hydrogen atom, an aliphatic hydrocarbon group, an alicyclic hydrocarbon group, an aromatic hydrocarbon group and an alkali metal; R^{h} and Rⁱ each are independently selected from a hydrogen atom, an aliphatic hydrocarbon group, an alicyclic hydrocarbon group, an aromatic hydrocarbon group and an acyl group; the —COO moiety may form a salt with an amine; the —NR^{h}Rⁱ moiety may form a salt with an acid; however, when all of R^{g}, R^{h} and Rⁱ are hydrogen atoms, the compound must form a salt, and in case where the compound does not form a salt, at least one of R^{g}, R^{h} and Rⁱ is not a hydrogen atom.

35. The method for producing a rubber composition according to claim 33, wherein the composition contains the guanidine compound (B-5) in an amount of from 0.1 to 3 parts by mass per 100 parts by mass of the rubber component (A).

36. The method for producing a rubber composition according to claim 33, wherein the nucleophilic reagent (B-4) except guanidine compounds is cysteine.

37. The method for producing a rubber composition according to claim 33, wherein a silane coupling agent (D) is added in the first kneading stage.

38. The method for producing a rubber composition according to claim 33, wherein the inorganic filler (C) is silica.

39. The method for producing a rubber composition according to claim 33, wherein the inorganic filler (C) accounts for 30% by mass or more in the filler.

40. The method for producing a rubber composition according to claim 33, wherein the guanidine compound (B-5) is 1,3-diphenylguanidine.

41. The method for producing a rubber composition according to claim 33, wherein the maximum temperature of the rubber composition in the first kneading stage is from 120 to 190° C.

42. A rubber composition that contains a rubber component (A),
a phosphorous acid compound (B-6) represented by the following general formula (IV) or a salt of the phosphorous acid compound (B-6),
a filler containing an inorganic filler (C), and
a silane coupling agent (D): 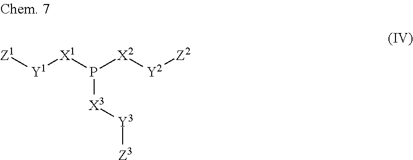
(wherein X¹, X² and X³ each independently represent an oxygen atom or —CH₂—; Y¹, Y² and Y³ each independently represent at least one selected from a single bond, a linear or branched aliphatic hydrocarbon group having from 1 to 6 carbon atoms, and an aromatic hydrocarbon group having from 6 to 20 carbon atoms; Z¹, Z² and Z³ each independently represent at least one selected from a hydrogen atom, a linear or branched aliphatic hydrocarbon group having from 1 to 6 carbon atoms, and a carboxyl group).

43. The rubber composition according to claim 42, wherein the ratio by mass of {the phosphorous acid compound (B-6) represented by the general formula (IV)/the silane coupling agent (D)} in the rubber composition is from (2/100) to (100/100).

44. A method for producing a rubber composition that contains a rubber component (A), a filler containing an inorganic filler (C), a silane coupling agent (D), and a phosphorous acid compound (B-6) represented by the general formula (IV) or a salt of the phosphorous acid compound (B-6); wherein the rubber composition is kneaded in plural stages, and in the first kneading stage, the rubber component (A), all or a part of the inorganic filler (C), all or a part of the silane coupling agent (D), and the phosphorous acid compound (B-6) represented by the following general formula (IV) or a salt of the phosphorous acid compound (B-6) are kneaded: 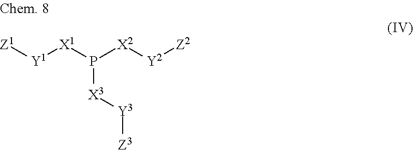
(wherein X¹, X² and X³ each independently represent an oxygen atom or —CH₂—; Y¹, Y² and Y³ each independently represent at least one selected from a single bond, a linear or branched aliphatic hydrocarbon group having from 1 to 6 carbon atoms, and an aromatic hydrocarbon group having from 6 to 20 carbon atoms; Z¹, Z² and Z³ each independently represent at least one selected from a hydrogen atom, a linear or branched aliphatic hydrocarbon group having from 1 to 6 carbon atoms, and a carboxyl group).

45. The method for producing a rubber composition according to claim 44, wherein in the first kneading stage, the rubber component (A), all or a part of the inorganic filler (C) and all or a part of the silane coupling agent (D) are kneaded, and then the phosphorous acid compound (B-6) or the salt of the phosphorous acid compound (B-6) is added thereto and further kneaded.

46. The rubber composition according to claim 1, wherein the silane coupling agent (D) comprises at least one compound selected from the group consisting of the compounds represented by the following general formulae (V) to (VIII):
Chem. 9
(R¹O)₃₋ₚ(R²)ₚSi—R³—Sₐ—R³—Si(OR¹)₃₋ᵣ(R)ᵣ (V)
wherein R¹, plural groups of which may be the same as or different from each other, each represent a hydrogen atom, a linear, cyclic or branched alkyl group having from 1 to 8 carbon atoms, or a linear or branched alkoxyalkyl group having from 2 to 8 carbon atoms; R², plural groups of which may be the same as or different from each other, each represent a linear, cyclic or branched alkyl group having from 1 to 8 carbon atoms; R³, plural groups of which may be the same as or different from each other, each represent a linear or branched alkylene group having from 1 to 8 carbon atoms; a represents a number of from 2 to 6 in terms of average value and p and r may be the same as or different from each other and each represent a number of from 0 to 3 in terms of average value, provided that both p and r are not 3 simultaneously; 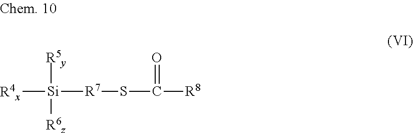
wherein R⁴ represents a monovalent group selected from —Cl, —Br, R⁹O—, R⁹C(═O)O—, R⁹R¹⁰C═NO—, R⁹R¹⁰CNO—, R⁹R¹⁰N— and —(OSiR⁹R¹⁰)ₕ(OSiR⁹R¹⁰R¹¹) (wherein R⁹, R¹⁰ and R¹¹ each represent a hydrogen atom or a monovalent hydrocarbon group having from 1 to 18 carbon atoms; and h represents a number of from 1 to 4 in terms of average value); R⁵ represents R⁴, a hydrogen atom or a monovalent hydrocarbon group having from 1 to 18 carbon atoms; R⁶ represents R⁴, R⁵, a hydrogen atom or a group represented by —(O(R¹²O)ⱼ)_{0.5} (wherein R¹² represents an alkylene group having from 1 to 18 carbon atoms; and j represents an integer of from 1 to 4); R⁷ represents a divalent hydrocarbon group having from 1 to 18 carbon atoms; R⁸ represents a monovalent hydrocarbon group having from 1 to 18 carbon atoms; and x, y and z represent numbers that satisfy relationships, x+y+2z=3, 0≦x≦3, 0≦y≦2, and 0≦z≦1;
Chem. 11
(R¹³O)₃₋ₛ(R¹⁴)ₛSi—R¹⁵—Sₖ—R¹⁶—Sₖ—R¹⁵—Si(OR¹³)₃₋ₜ(R¹⁴)ₜ (VII)
wherein R¹³, plural groups of which may be the same as or different from each other, each represent a hydrogen atom, a linear, cyclic or branched alkyl group having from 1 to 8 carbon atoms, or a linear or branched alkoxyalkyl group having from 2 to 8 carbon atoms; R¹⁴, plural groups of which may be the same as or different from each other, each represent a linear, cyclic or branched alkyl group having from 1 to 8 carbon atoms; R¹⁵, plural groups of which may be the same as or different from each other, each represent a linear or branched alkylene group having from 1 to 8 carbon atoms; R¹⁶ represents a divalent group selected from (—S—R¹⁷—S—), (—R¹⁸—Sₘ₁—R¹⁹—) and (—R²⁰—Sₘ₂—R²¹—Sₘ₃—R²²—) (wherein R¹⁷ to R²² each represent a divalent hydrocarbon group having from 1 to 20 carbon atoms, a divalent aromatic group or a divalent organic group containing a hetero element other than sulfur and oxygen; and m1, m2 and m3 each represent a number of 1 or more and less than 4 in terms of average value); k, plural numbers of which may be the same as or different from each other, each represent a number of from 1 to 6 in terms of average value; and s and t each represent a number of from 0 to 3 in terms of average value, provided that both s and t are not 3 simultaneously; and 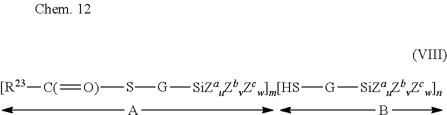
wherein R²³ represents a linear, branched or cyclic alkyl group having from 1 to 20 carbon atoms; G, plural groups of which may be the same as or different from each other, each represent an alkanediyl group or an alkenediyl group each having from 1 to 9 carbon atoms; Z^{a}, plural groups of which may be the same as or different from each other, each represent a group that is capable of being bonded to two silicon atoms and represent a functional group selected from (—O—)_{0.5}, (—O-G-)_{0.5} and (—O-G-O—)_{0.5}; Z^{b}, plural groups of which may be the same as or different from each other, each represent a group that is capable of being bonded to two silicon atoms and represent a functional group represented by (—O-G-O—)_{0.5}; Z^{c}, plural groups of which may be the same as or different from each other, each represent a functional group selected from —Cl, —Br, —OR^{x}, R^{x}C(═O)O—, R^{x}R^{y}C═NO—, R^{x}R^{y}N—, R^{x}— and HO-G-O— (wherein G agrees with the aforementioned expression); R^{x} and R^{y} each represent a linear, branched or cyclic alkyl group having from 1 to 20 carbon atoms; m, n, u, v and w satisfy 1≦m≦20, 0≦n≦20, 0≦u≦3, 0≦v≦2, 0≦w≦1, and (u/2)+v+2w=2 or 3; when there are plural moieties represented by A, Z^{a}ᵤ, Z^{b}ᵥ and Z^{c}_{w} each in the plural moieties represented by A may each be the same as or different from each other; and when there are plural moieties represented by B, Z^{a}ᵤ, Z^{b}ᵥ and Z^{c}_{w} each in the plural moieties represented by B may each be the same as or different from each other.

47. The method for producing a rubber composition according to claim 10, wherein the silane coupling agent (D) comprises at least one compound selected from the group consisting of the compounds represented by the following general formulae (V) to (VIII):
Chem. 13
(R¹O)₃₋ₚ(R²)ₚSi—R³—Sₐ—R³—Sₐ—R³—Si(OR¹)₃₋ᵣ(R²)ᵣ (V)
wherein R¹, plural groups of which may be the same as or different from each other, each represent a hydrogen atom, a linear, cyclic or branched alkyl group having from 1 to 8 carbon atoms, or a linear or branched alkoxyalkyl group having from 2 to 8 carbon atoms; R², plural groups of which may be the same as or different from each other, each represent a linear, cyclic or branched alkyl group having from 1 to 8 carbon atoms; R³, plural groups of which may be the same as or different from each other, each represent a linear or branched alkylene group having from 1 to 8 carbon atoms; a represents a number of from 2 to 6 in terms of average value and p and r may be the same as or different from each other and each represent a number of from 0 to 3 in terms of average value, provided that both p and r are not 3 simultaneously; 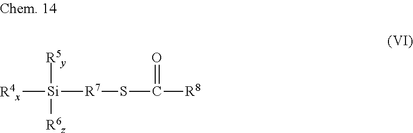
wherein R⁴ represents a monovalent group selected from —Cl, —Br, R⁹O—, R⁹C(═O)O—, R⁹R¹⁰C═NO—, R⁹R¹⁰CNO—, R⁹R¹⁰N— and —(OSiR⁹R¹⁰)ₕ(OSiR⁹R¹⁰R¹¹) (wherein R⁹, R¹⁰ and R¹¹ each represent a hydrogen atom or a monovalent hydrocarbon group having from 1 to 18 carbon atoms; and h represents a number of from 1 to 4 in terms of average value); R⁵ represents R⁴, a hydrogen atom or a monovalent hydrocarbon group having from 1 to 18 carbon atoms; R⁶ represents R⁴, R⁵, a hydrogen atom or a group represented by —(O(R¹²O)ⱼ)_{0.5} (wherein R¹² represents an alkylene group having from 1 to 18 carbon atoms; and j represents an integer of from 1 to 4); R⁷ represents a divalent hydrocarbon group having from 1 to 18 carbon atoms; R⁸ represents a monovalent hydrocarbon group having from 1 to 18 carbon atoms; and x, y and z represent numbers that satisfy relationships, x+y+2z=3, 0≦x≦3, 0≦y≦2, and 0≦z≦1;
Chem. 15
(R¹³O)₃₋ₛ(R¹⁴)ₛSi—R¹⁵—Sₖ—R¹⁶—Sₖ—R¹⁵—Si(OR¹³)₃₋ₜ(R¹⁴)ₜ (VII)
wherein R¹³, plural groups of which may be the same as or different from each other, each represent a hydrogen atom, a linear, cyclic or branched alkyl group having from 1 to 8 carbon atoms, or a linear or branched alkoxyalkyl group having from 2 to 8 carbon atoms; R¹⁴, plural groups of which may be the same as or different from each other, each represent a linear, cyclic or branched alkyl group having from 1 to 8 carbon atoms; R¹⁵, plural groups of which may be the same as or different from each other, each represent a linear or branched alkylene group having from 1 to 8 carbon atoms; R¹⁶ represents a divalent group selected from (—S—R¹⁷—S—), (—R¹⁸—Sₘ₁—R¹⁹—) and (—R²⁰—Sₘ₂—R²¹—Sₘ₃—R²²—) (wherein R¹⁷ to R²² each represent a divalent hydrocarbon group having from 1 to 20 carbon atoms, a divalent aromatic group or a divalent organic group containing a hetero element other than sulfur and oxygen; and m1, m2 and m3 each represent a number of 1 or more and less than 4 in terms of average value); k, plural numbers of which may be the same as or different from each other, each represent a number of from 1 to 6 in terms of average value; and s and t each represent a number of from 0 to 3 in terms of average value, provided that both s and t are not 3 simultaneously; and 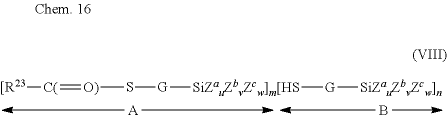
wherein R²³ represents a linear, branched or cyclic alkyl group having from 1 to 20 carbon atoms; G, plural groups of which may be the same as or different from each other, each represent an alkanediyl group or an alkenediyl group each having from 1 to 9 carbon atoms; Z^{a}, plural groups of which may be the same as or different from each other, each represent a group that is capable of being bonded to two silicon atoms and represent a functional group selected from (—O—)_{0.5}, (—O-G-)_{0.5} and (—O-G-O—)_{0.5}; Z^{b}, plural groups of which may be the same as or different from each other, each represent a group that is capable of being bonded to two silicon atoms and represent a functional group represented by (—O-G-O—)_{0.5}; Z^{c}, plural groups of which may be the same as or different from each other, each represent a functional group selected from —Cl, —Br, —OR^{x}, R^{x}C(═O)O—, R^{x}R^{y}C═NO—, R^{x}R^{y}N—, R^{x}— and HO-G-O— (wherein G agrees with the aforementioned expression); R^{x} and R^{y} each represent a linear, branched or cyclic alkyl group having from 1 to 20 carbon atoms; m, n, u, v and w satisfy 1≦m≦20, 0≦n≦20, 0≦u≦3, 0≦v≦2, 0≦w≦1, and (u/2)+v+2w=2 or 3; when there are plural moieties represented by A, Z^{a}ᵤ, Z^{b}ᵥ and Z^{c}_{w} each in the plural moieties represented by A may each be the same as or different from each other; and when there are plural moieties represented by B, Z^{a}ᵤ, Z^{b}ᵥ and Z^{c}_{w} each in the plural moieties represented by B may each be the same as or different from each other.
